(19) United States
(12) Patent Application Publication
(10) Pub. No.: US 2024/0219686 A1
(43) Pub. Date: Jul. 4, 2024

(54) Lens Assembly

(71) Applicants: Sintai Optical (Shenzhen) Co., Ltd., ShenZhen City (CN); Asia Optical Co., Inc., Taichung (TW)

(72) Inventors: Wen-Chieh Chen, Taichung (TW); Yu-Wen Tai, Taichung (TW)

(21) Appl. No.: 18/530,293

(22) Filed: Dec. 6, 2023

(30) Foreign Application Priority Data
Dec. 27, 2022 (CN) 202211680627.7

(51) Int. Cl. G02B 9/62

(52) U.S. Cl. CPC G02B 9/62

(57) ABSTRACT

A lens assembly includes a first lens, a second lens, a third lens, a fourth lens, a fifth lens, and a sixth lens. The first lens is with negative refractive power. The second lens is with refractive power. The third lens is with positive refractive power and includes a convex surface facing an image side. The fourth lens is with positive refractive power and includes a convex surface facing an object side. The fifth lens is with refractive power. The sixth lens is with refractive power. The first lens, the second lens, the third lens, the fourth lens, the fifth lens, and the sixth lens are arranged in order from the object side to the image side along an optical axis.

### BACKGROUND OF THE INVENTION

### Field of the Invention

The present invention relates to a lens assembly.

### Description of the Related Art

The current development trend of a lens assembly is toward large field of view. Additionally, the lens assembly is developed to have small F-number and high resolution in accordance with different application requirements. However, the known lens assembly can't satisfy such requirements. Therefore, the lens assembly needs a new structure in order to meet the requirements of large field of view, small F-number, and high resolution at the same time.

### BRIEF SUMMARY OF THE INVENTION

The invention provides a lens assembly to solve the above problems. The lens assembly of the invention is provided with characteristics of an increased field of view, a decreased F-number, an increased resolution, and still has a good optical performance.

The lens assembly in accordance with an exemplary embodiment of the invention includes a first lens, a second lens, a third lens, a fourth lens, a fifth lens, and a sixth lens. The first lens is with negative refractive power. The second lens is with refractive power. The third lens is with positive refractive power and includes a convex surface facing an image side. The fourth lens is with positive refractive power and includes a convex surface facing an object side. The fifth lens is with refractive power. The sixth lens is with refractive power. The first lens, the second lens, the third lens, the fourth lens, the fifth lens, and the sixth lens are arranged in order from the object side to the image side along an optical axis. The lens assembly satisfies the following condition: −17 degree/mm≤FOV/f1≤−4 degree/mm; wherein FOV is a field of view of the lens assembly and f1 is an effective focal length of the first lens. The lens assembly satisfies at least one of the following conditions: 200 mm²≤f×tan(FOV/2)×TTL≤220 mm²; 0.8≤Td12/Td34≤1.1; 25.2≤Td34/Td45≤61.8; wherein FOV is the field of view of the lens assembly, f is an effective focal length of the lens assembly, TTL is an interval from an object side surface of the first lens to an image plane along the optical axis, Td12 is an air interval from an image side surface of the first lens to an object side surface of the second lens along the optical axis, Td34 is an air interval from an image side surface of the third lens to an object side surface of the fourth lens along the optical axis, and Td45 is an air interval from an image side surface of the fourth lens to an object side surface of the fifth lens along the optical axis.

In another exemplary embodiment, the first lens is a meniscus lens and includes a convex surface facing the object side and a concave surface facing the image side; the second lens is with negative refractive power; and the fourth lens includes a convex surface facing the image side.

In yet another exemplary embodiment, the second lens is a meniscus lens and includes a concave surface facing the object side and a convex surface facing the image side; the third lens further includes a concave surface facing the object side; the fifth lens is a biconcave lens with negative refractive power and includes a concave surface facing the object side and another concave surface facing the image side; the sixth lens is a biconvex lens with positive refractive power and includes a convex surface facing the object side and another convex surface facing the image side; and the fifth lens and the sixth lens are cemented.

In another exemplary embodiment, the lens assembly further includes a stop disposed between the third lens and the fourth lens, wherein the lens assembly satisfies at least one of the following conditions: 1.4≤CT4/LAT2≤3.2; 0.95≤f4/f≤3.45; 0.4≤Vd2/Vd3≤2.2; 2≤Vd4/Vd5≤4.1; 0.3≤Vd5/Vd6≤0.42; 3 mm≤|R22-R31|≤80 mm; 1.2≤f3/f≤6.8; −21.5 mm≤(R21×R22)/f2≤32.5 mm; −15≤(f1+f2)/f≤−3; −111≤fF/f≤2.2; 0.1≤Tz/BFL≤1.4; 62≤Vd4≤68; 4≤dSI/Td23≤94; 5.9≤(R41-R32)/CT6≤15.1; 0.05≤CT2/Td23≤13.35; 0.9≤CT3/Td23≤9.9; 0.4≤CT4/Td23≤11.8; 0.7≤CT6/Td23≤14.3; wherein CT2 is an interval from the object side surface of the second lens to an image side surface of the second lens along the optical axis, CT3 is an interval from an object side surface of the third lens to the image side surface of the third lens along the optical axis, CT4 is an interval from the object side surface of the fourth lens to the image side surface of the fourth lens along the optical axis, CT6 is an interval from an object side surface of the sixth lens to an image side surface of the sixth lens along the optical axis, LAT2 is an interval from the outermost edge of the object side surface of the fourth lens to the outermost edge of the image side surface of the fourth lens along the optical axis, f1 is the effective focal length of the first lens, f2 is an effective focal length of the second lens, f3 is an effective focal length of the third lens, f4 is an effective focal length of the fourth lens, f is the effective focal length of the lens assembly, fF is an effective focal length of a combination of the lenses between the object side and the stop, Tz is an interval from an object side surface of the lens closest to the image side to an image side surface of the lens closest to the image side along the optical axis, BFL is an interval from the image side surface of the lens closest to the image side to the image plane along the optical axis, dSI is an interval from the stop to the image plane along the optical axis, Vd2 is an Abbe number of the second lens, Vd3 is an Abbe number of the third lens, Vd4 is an Abbe number of the fourth lens, Vd5 is an Abbe number of the fifth lens, Vd6 is an Abbe number of the sixth lens, R21 is a radius of curvature of the object side surface of the second lens, R22 is a radius of curvature of the image side surface of the second lens, R31 is a radius of curvature of the object side surface of the third lens, R32 is a radius of curvature of the image side surface of the third lens, R41 is a radius of curvature of the object side surface of the fourth lens, and Td23 is an air interval from the image side surface of the second lens to the object side surface of the third lens along the optical axis.

In yet another exemplary embodiment, the lens assembly further includes a seventh lens disposed between the sixth lens and the image side, wherein: the second lens is a biconcave lens and includes a concave surface facing the object side and another concave surface facing the image side; the third lens is a biconvex lens and further includes another convex surface facing the object side; the fifth lens is a biconcave lens with negative refractive power and includes a concave surface facing the object side and another concave surface facing the image side; the sixth lens is a biconvex lens with positive refractive power and includes a convex surface facing the object side and another convex surface facing the image side; the seventh lens is a biconvex lens with positive refractive power and includes a convex surface facing the object side and another convex surface facing the image side; and the fifth lens and the sixth lens are cemented.

In another exemplary embodiment, the lens assembly further includes a seventh lens disposed between the sixth lens and the image side, wherein: the second lens is a biconcave lens and includes a concave surface facing the object side and another concave surface facing the image side; the third lens is a biconvex lens and further includes another convex surface facing the object side; the fifth lens is a biconcave lens with negative refractive power and includes a concave surface facing the object side and another concave surface facing the image side; the sixth lens is a biconvex lens with positive refractive power and includes a convex surface facing the object side and another convex surface facing the image side; and the seventh lens is a meniscus lens with positive refractive power and includes a convex surface facing the object side and a concave surface facing the image side.

In yet another exemplary embodiment, the second lens is a meniscus lens and includes a concave surface facing the object side and a convex surface facing the image side; the third lens is a biconvex lens and further includes another convex surface facing the object side; the fifth lens is a biconcave lens with negative refractive power and includes a concave surface facing the object side and another concave surface facing the image side; and the sixth lens is a biconvex lens with positive refractive power and includes a convex surface facing the object side and another convex surface facing the image side.

In another exemplary embodiment, the lens assembly further includes a seventh lens disposed between the sixth lens and the image side, wherein: the second lens is a biconcave lens and includes a concave surface facing the object side and another concave surface facing the image side; the third lens is a biconvex lens and further includes another convex surface facing the object side; the fifth lens is a meniscus lens with positive refractive power and includes a concave surface facing the object side and a convex surface facing the image side; the sixth lens is a biconcave lens with negative refractive power and includes a concave surface facing the object side and another concave surface facing the image side; the seventh lens is a biconvex lens with positive refractive power and includes a convex surface facing the object side and another convex surface facing the image side; and the fifth lens and the sixth lens are cemented.

In yet another exemplary embodiment, the lens assembly further includes a stop disposed between the third lens and the fourth lens, wherein the lens assembly satisfies at least one of the following conditions: 0.95≤f4/f≤3.45; 0.4≤Vd2/Vd3≤2.2; 3 mm≤|R22-R31|≤80 mm; 1.2≤f3/f≤6.8; −21.5 mm≤(R21×R22)/f2≤32.5 mm; −15≤(f1+f2)/f≤−3; −111≤fF/f≤2.2; 0.1≤Tz/BFL≤1.4; 62≤Vd4≤68; 4≤dSI/Td23≤94; 0.05≤CT2/Td23≤13.35; 0.9≤CT3/Td23≤9.9; 0.4≤CT4/Td23≤11.8; 0.7≤CT6/Td23≤14.3; wherein CT2 is an interval from the object side surface of the second lens to an image side surface of the second lens along the optical axis, CT3 is an interval from an object side surface of the third lens to the image side surface of the third lens along the optical axis, CT4 is an interval from the object side surface of the fourth lens to the image side surface of the fourth lens along the optical axis, CT6 is an interval from an object side surface of the sixth lens to an image side surface of the sixth lens along the optical axis, f1 is the effective focal length of the first lens, f2 is an effective focal length of the second lens, f3 is an effective focal length of the third lens, f4 is an effective focal length of the fourth lens, f is the effective focal length of the lens assembly, fF is an effective focal length of a combination of the lenses between the object side and the stop, Tz is an interval from an object side surface of the lens closest to the image side to an image side surface of the lens closest to the image side along the optical axis, BFL is an interval from the image side surface of the lens closest to the image side to the image plane along the optical axis, dSI is an interval from the stop to the image plane along the optical axis, Vd2 is an Abbe number of the second lens, Vd3 is an Abbe number of the third lens, Vd4 is an Abbe number of the fourth lens, R21 is a radius of curvature of the object side surface of the second lens, R22 is a radius of curvature of the image side surface of the second lens, R31 is a radius of curvature of the object side surface of the third lens, and Td23 is an air interval from the image side surface of the second lens to the object side surface of the third lens along the optical axis.

The lens assembly in accordance with another exemplary embodiment of the invention includes a first lens, a second lens, a third lens, a fourth lens, a fifth lens, a sixth lens, and a seventh lens. The first lens which is with negative refractive power. The second lens which is with refractive power. The third lens is with positive refractive power and includes a convex surface facing an image side. The fourth lens is with positive refractive power and includes a convex surface facing an object side. The fifth lens is with refractive power. The sixth lens is with refractive power. The seventh lens is with refractive power. The first lens, the second lens, the third lens, the fourth lens, the fifth lens, the sixth lens, and the seventh lens are arranged in order from the object side to the image side along an optical axis.

In another exemplary embodiment, the first lens is a meniscus lens and includes a convex surface facing the object side and a concave surface facing the image side; the second lens is a meniscus lens with negative refractive power and includes a convex surface facing the object side and a concave surface facing the image side; the third lens is a biconvex lens and further includes another convex surface facing the object side; the fourth lens is a biconvex lens and further includes another convex surface facing the image side; the fifth lens is a biconcave lens with negative refractive power and includes a concave surface facing the object side and another concave surface facing the image side; the sixth lens is a biconvex lens with positive refractive power and includes a convex surface facing the object side and another convex surface facing the image side; and the seventh lens is a meniscus lens with positive refractive power and includes a concave surface facing the object side and a convex surface facing the image side.

In yet another exemplary embodiment, the lens assembly further includes an eighth lens disposed between the sixth lens and the image side, wherein: the first lens is a meniscus lens and includes a convex surface facing the object side and a concave surface facing the image side; the second lens is a biconcave lens with negative refractive power and includes a concave surface facing the object side and another concave surface facing the image side; the third lens is a meniscus lens and further includes a concave surface facing the object side; the fourth lens is a biconvex lens and further includes another convex surface facing the image side; the fifth lens is a meniscus lens with negative refractive power and includes a convex surface facing the object side and a concave surface facing the image side; the sixth lens is a biconvex lens with positive refractive power and includes a convex surface facing the object side and another convex surface facing the image side; the seventh lens is a biconvex lens with positive refractive power and includes a convex surface facing the object side and another convex surface facing the image side; the eighth lens is a meniscus lens with negative refractive power and includes a concave surface facing the object side and a convex surface facing the image side; and the fifth lens and the sixth lens are cemented.

In another exemplary embodiment, the lens assembly further includes a stop disposed between the third lens and the fourth lens, wherein the lens assembly satisfies at least one of the following conditions: 1.4≤CT4/LAT2≤3.2; 0.95≤f4/f≤3.45; 0.4≤Vd2/Vd3≤2.2; 2≤Vd4/Vd5≤4.1; 0.3≤Vd5/Vd6≤0.42; 3 mm≤|R22−R31|≤80 mm; 1.2≤f3/f≤6.8; −17 degree/mm≤FOV/f1≤−4 degree/mm; −21.5 mm≤(R21×R22)/f2≤32.5 mm; −15≤(f1+f2)/f≤−3; −111≤fF/f≤2.2; 0.1≤Tz/BFL≤1.4; 62≤Vd4≤68; 4≤dSI/Td23≤94; 5.9≤(R41−R32)/CT6≤15.1; 0.05≤CT2/Td23≤13.35; 0.9≤CT3/Td23≤9.9; 0.4≤CT4/Td23≤11.8; 0.7≤CT6/Td23≤14.3; wherein FOV is a field of view of the lens assembly, CT2 is an interval from the object side surface of the second lens to an image side surface of the second lens along the optical axis, CT3 is an interval from an object side surface of the third lens to the image side surface of the third lens along the optical axis, CT4 is an interval from the object side surface of the fourth lens to the image side surface of the fourth lens along the optical axis, CT6 is an interval from an object side surface of the sixth lens to an image side surface of the sixth lens along the optical axis, LAT2 is an interval from the outermost edge of the object side surface of the fourth lens to the outermost edge of the image side surface of the fourth lens along the optical axis, f1 is the effective focal length of the first lens, f2 is an effective focal length of the second lens, f3 is an effective focal length of the third lens, f4 is an effective focal length of the fourth lens, f is the effective focal length of the lens assembly, fF is an effective focal length of a combination of the lenses between the object side and the stop, Tz is an interval from an object side surface of the lens closest to the image side to an image side surface of the lens closest to the image side along the optical axis, BFL is an interval from the image side surface of the lens closest to the image side to the image plane along the optical axis, dSI is an interval from the stop to the image plane along the optical axis, Vd2 is an Abbe number of the second lens, Vd3 is an Abbe number of the third lens, Vd4 is an Abbe number of the fourth lens, Vd5 is an Abbe number of the fifth lens, Vd6 is an Abbe number of the sixth lens, R21 is a radius of curvature of the object side surface of the second lens, R22 is a radius of curvature of the image side surface of the second lens, R31 is a radius of curvature of the object side surface of the third lens, R32 is a radius of curvature of the image side surface of the third lens, R41 is a radius of curvature of the object side surface of the fourth lens, and Td23 is an air interval from the image side surface of the second lens to the object side surface of the third lens along the optical axis.

In yet another exemplary embodiment, the first lens is a meniscus lens and includes a convex surface facing the object side and a concave surface facing the image side; the second lens is a meniscus lens with negative refractive power and includes a concave surface facing the object side and a convex surface facing the image side; the third lens is a biconvex lens and further includes another convex surface facing the object side; the fourth lens is a biconvex lens and further includes another convex surface facing the image side; the fifth lens is a biconcave lens with negative refractive power and includes a concave surface facing the object side and another concave surface facing the image side; the sixth lens is a biconvex lens with positive refractive power and includes a convex surface facing the object side and another convex surface facing the image side; and the seventh lens is a meniscus lens with positive refractive power and includes a concave surface facing the object side and a convex surface facing the image side.

In another exemplary embodiment, the lens assembly further includes a stop disposed between the third lens and the fourth lens, wherein the lens assembly satisfies at least one of the following conditions: 1.4≤CT4/LAT2≤3.2; 0.95≤f4/f≤3.45; 0.4≤Vd2/Vd3≤2.2; 2≤Vd4/Vd5≤4.1; 0.3≤Vd5/Vd6≤0.42; 1.2≤f3/f≤6.8; −17 degree/mm≤FOV/f1≤−4 degree/mm; −15≤(f1+f2)/f≤−3; 0.1≤Tz/BFL≤1.4; 4≤dSI/Td23≤94; 0.05≤CT2/Td23≤13.35; 0.9≤CT3/Td23≤9.9; 0.4≤CT4/Td23≤11.8; 0.7≤CT6/Td23≤14.3; wherein FOV is a field of view of the lens assembly, CT2 is an interval from the object side surface of the second lens to an image side surface of the second lens along the optical axis, CT3 is an interval from an object side surface of the third lens to the image side surface of the third lens along the optical axis, CT4 is an interval from the object side surface of the fourth lens to the image side surface of the fourth lens along the optical axis, CT6 is an interval from an object side surface of the sixth lens to an image side surface of the sixth lens along the optical axis, LAT2 is an interval from the outermost edge of the object side surface of the fourth lens to the outermost edge of the image side surface of the fourth lens along the optical axis, f1 is the effective focal length of the first lens, f2 is an effective focal length of the second lens, f3 is an effective focal length of the third lens, f4 is an effective focal length of the fourth lens, f is the effective focal length of the lens assembly, Tz is an interval from an object side surface of the lens closest to the image side to an image side surface of the lens closest to the image side along the optical axis, BFL is an interval from the image side surface of the lens closest to the image side to the image plane along the optical axis, dSI is an interval from the stop to the image plane along the optical axis, Vd2 is an Abbe number of the second lens, Vd3 is an Abbe number of the third lens, Vd4 is an Abbe number of the fourth lens, Vd5 is an Abbe number of the fifth lens, Vd6 is an Abbe number of the sixth lens, and Td23 is an air interval from the image side surface of the second lens to the object side surface of the third lens along the optical axis.

The lens assembly in accordance with yet another exemplary embodiment of the invention includes a first lens, a second lens, a third lens, a fourth lens, a fifth lens, a sixth lens, and a seventh lens. The first lens which is with negative refractive power. The second lens which is with refractive power. The third lens is with positive refractive power and includes a convex surface facing an image side. The fourth lens is with positive refractive power and includes a convex surface facing an object side. The fifth lens is with refractive power. The sixth lens is with refractive power. The seventh lens is with refractive power. The first lens, the second lens, the third lens, the fourth lens, the fifth lens, the sixth lens, and the seventh lens are arranged in order from the object side to the image side along an optical axis.

In another exemplary embodiment, the first lens is a meniscus lens and includes a convex surface facing the object side and a concave surface facing the image side; the second lens is a meniscus lens with negative refractive power and includes a convex surface facing the object side and a concave surface facing the image side; the third lens is a meniscus lens and further includes a concave surface facing the object side; the fourth lens is a biconvex lens and further includes another convex surface facing the image side; the fifth lens is a meniscus lens with negative refractive power and includes a convex surface facing the object side and a concave surface facing the image side; the sixth lens is a biconvex lens with positive refractive power and includes a convex surface facing the object side and another convex surface facing the image side; the seventh lens is a meniscus lens with negative refractive power and includes a concave surface facing the object side and a convex surface facing the image side; and the fifth lens and the sixth lens are cemented.

In yet another exemplary embodiment, the lens assembly further includes a stop disposed between the third lens and the fourth lens, wherein the lens assembly satisfies at least one of the following conditions: 1.4≤CT4/LAT2≤3.2; 0.95≤f4/f≤3.45; 0.4≤Vd2/Vd3≤2.2; 2≤Vd4/Vd5≤4.1; 0.3≤Vd5/Vd6≤0.42; 3 mm≤|R22-R31|≤80 mm; 1.2≤f3/f≤6.8; −17 degree/mm≤FOV/f1≤−4 degree/mm; −21.5 mm≤(R21×R22)/f2≤32.5 mm; −15≤(f1+f2)/f≤−3; −111≤fF/f≤2.2; 0.1≤Tz/BFL≤1.4; 4≤dSI/Td23≤94; 5.9≤(R41-R32)/CT6≤15.1; 0.05≤CT2/Td23≤13.35; 0.9≤CT3/Td23≤9.9; 0.4≤CT4/Td23≤11.8; 0.7≤CT6/Td23≤14.3; wherein FOV is a field of view of the lens assembly, CT2 is an interval from the object side surface of the second lens to an image side surface of the second lens along the optical axis, CT3 is an interval from an object side surface of the third lens to the image side surface of the third lens along the optical axis, CT4 is an interval from the object side surface of the fourth lens to the image side surface of the fourth lens along the optical axis, CT6 is an interval from an object side surface of the sixth lens to an image side surface of the sixth lens along the optical axis, LAT2 is an interval from the outermost edge of the object side surface of the fourth lens to the outermost edge of the image side surface of the fourth lens along the optical axis, f1 is the effective focal length of the first lens, f2 is an effective focal length of the second lens, f3 is an effective focal length of the third lens, f4 is an effective focal length of the fourth lens, f is the effective focal length of the lens assembly, fF is an effective focal length of a combination of the lenses between the object side and the stop, Tz is an interval from an object side surface of the lens closest to the image side to an image side surface of the lens closest to the image side along the optical axis, BFL is an interval from the image side surface of the lens closest to the image side to the image plane along the optical axis, dSI is an interval from the stop to the image plane along the optical axis, Vd2 is an Abbe number of the second lens, Vd3 is an Abbe number of the third lens, Vd4 is an Abbe number of the fourth lens, Vd5 is an Abbe number of the fifth lens, Vd6 is an Abbe number of the sixth lens, R21 is a radius of curvature of the object side surface of the second lens, R22 is a radius of curvature of the image side surface of the second lens, R31 is a radius of curvature of the object side surface of the third lens, R32 is a radius of curvature of the image side surface of the third lens, R41 is a radius of curvature of the object side surface of the fourth lens, and Td23 is an air interval from the image side surface of the second lens to the object side surface of the third lens along the optical axis.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout diagram of a lens assembly in accordance with a first embodiment of the invention;

FIGS. 2, 3, 4, 5 depict a longitudinal aberration diagram, a field curvature diagram, a distortion diagram, and a lateral color diagram of the lens assembly in accordance with the first embodiment of the invention, respectively;

FIG. 6 is a lens layout diagram of a lens assembly in accordance with a second embodiment of the invention;

FIGS. 7, 8, 9, 10 depict a longitudinal aberration diagram, a field curvature diagram, a distortion diagram, and a lateral color diagram of the lens assembly in accordance with the second embodiment of the invention, respectively;

FIG. 11 is a lens layout diagram of a lens assembly in accordance with a third embodiment of the invention;

FIG. 12 is a lens layout and optical path diagram of a lens assembly in accordance with a fourth embodiment of the invention;

FIGS. 13, 14, 15 depict a longitudinal aberration diagram, a field curvature diagram, and a distortion diagram of the lens assembly in accordance with the fourth embodiment of the invention, respectively;

FIGS. 16, 17, 18 are lens layout and optical path diagrams of lens assemblies in accordance with a fifth, a sixth, a seventh embodiments of the invention, respectively;

FIGS. 19, 20, 21 depict a longitudinal aberration diagram, a field curvature diagram, and a distortion diagram of the lens assembly in accordance with the seventh embodiment of the invention, respectively;

FIG. 22 is a lens layout diagram of a lens assembly in accordance with an eighth embodiment of the invention;

FIGS. 23, 24, 25, 26 depict a longitudinal aberration diagram, a field curvature diagram, a distortion diagram, and a lateral color diagram of the lens assembly in accordance with the eighth embodiment of the invention, respectively;

FIG. 27 is a lens layout diagram of a lens assembly in accordance with a ninth embodiment of the invention;

FIGS. 28, 29, 30, 31 depict a longitudinal aberration diagram, a field curvature diagram, a distortion diagram, and a lateral color diagram of the lens assembly in accordance with the ninth embodiment of the invention, respectively;

FIG. 32 is a lens layout and optical path diagram of a lens assembly in accordance with a tenth embodiment of the invention; and

FIGS. 33, 34, 35, 36 depict a longitudinal aberration diagram, a field curvature diagram, a distortion diagram, and a lateral color diagram of the lens assembly in accordance with the tenth embodiment of the invention, respectively.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a lens assembly including a first lens, a second lens, a third lens, a fourth lens, a fifth lens, and a sixth lens. The first lens is with negative refractive power. The second lens is with refractive power. The third lens is with positive refractive power and includes a convex surface facing an image side. The fourth lens is with positive refractive power and includes a convex surface facing an object side. The fifth lens is with refractive power. The sixth lens is with refractive power. The first lens, the second lens, the third lens, the fourth lens, the fifth lens, and the sixth lens are arranged in order from the object side to the image side along an optical axis. The lens assembly satisfies at least one of the following conditions: −17 degree/mm≤FOV/f1≤−4 degree/mm; 200 mm²≤f×tan(FOV/2)×TTL≤220 mm²; 0.8≤Td12/Td34≤1.1; 25.2≤Td34/Td45≤61.8; wherein FOV is a field of view of the lens assembly, f1 is an effective focal length of the first lens, f is an effective focal length of the lens assembly, TTL is an interval from an object side surface of the first lens to an image plane along the optical axis, Td12 is an air interval from an image side surface of the first lens to an object side surface of the second lens along the optical axis, Td34 is an air interval from an image side surface of the third lens to an object side surface of the fourth lens along the optical axis, and Td45 is an air interval from an image side surface of the fourth lens to an object side surface of the fifth lens along the optical axis. A lens assembly of the present invention is a preferred embodiment of the present invention when the lens assembly satisfies the above features.

Referring to Table 1, Table 2, Table 4, Table 5, Table 7, Table 8, Table 10, Table 11, Table 13, Table 14, Table 16, Table 17, Table 19, Table 20, Table 22, and Table 23, wherein Table 1, Table 4, Table 7, Table 10, Table 13, Table 16, Table 19, and Table 22 show optical specification in accordance with a first, second, third, fourth, fifth, sixth, and seventh embodiments of the invention, respectively and Table 2, Table 5, Table 8, Table 11, Table 14, Table 17, Table 20, and Table 23 show aspheric coefficients of each aspheric lens in Table 1, Table 4, Table 7, Table 10, Table 13, Table 16, Table 19, and Table 22, respectively. The aspheric surface sag z of each aspheric lens in the following embodiments can be calculated by the following formula: z=ch²/{1+[1−(k+1)c²h²]^{1/2}}+Ah⁴+Bh⁶+Ch⁸+Dh¹⁰+Eh¹²+Fh¹⁴+Gh¹⁶, where c is curvature, h is the vertical distance from the lens surface to the optical axis, k is conic constant, A, B, C, D, E, F, and G are aspheric coefficients, and the value of the aspheric coefficient A, B, C, D, E, F, and G are presented in scientific notation, such as 2E-03 for 2×10−3.

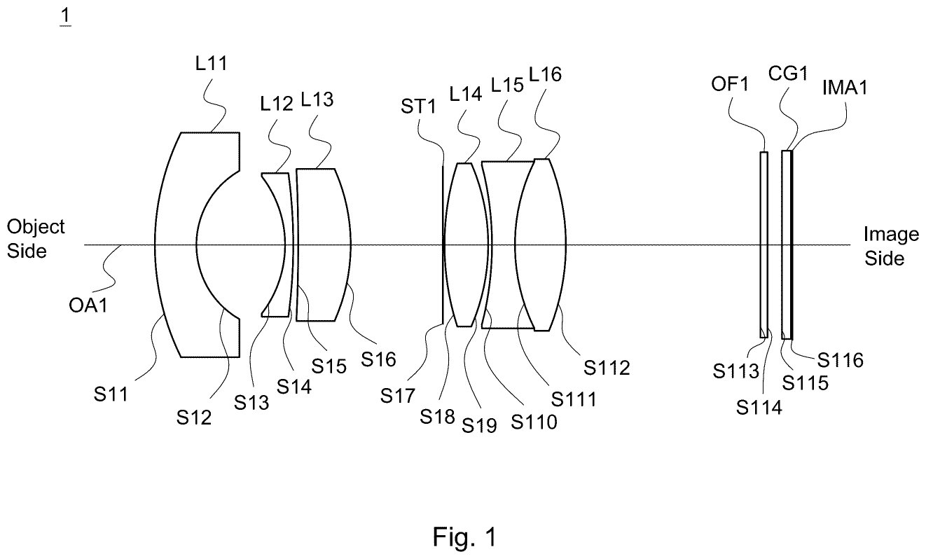

FIGS. 1, 6, 11, 12, 16, 17, 18, 22 are lens layout diagrams of the lens assemblies in accordance with the first, second, third, fourth, fifth, sixth, seventh, and eighth embodiments of the invention, respectively.

The first lenses L11, L21, L31, L41, L51, L61, L71, L81 are meniscus lenses with negative refractive power and made of glass material, wherein the object side surfaces S11, S21, S31, S41, S51, S61, S71, S81 are convex surfaces and the image side surfaces S12, S22, S32, S42, S52, S62, S72, S82 are concave surfaces.

The second lenses L12, L22, L32, L42, L52, L62, L72, L82 are with negative refractive power and made of glass material, wherein both of the object side surfaces S13, S23, S33, S45, S53, S65, S75, S83 and image side surfaces S14, S24, S34, S46, S54, S66, S76, S84 are spherical surfaces.

The third lenses L13, L23, L33, L43, L53, L63, L73, L83 are with positive refractive power and made of glass material, wherein the image side surfaces S16, S26, S36, S48, S56, S68, S78, S86 are convex surfaces.

The fourth lenses L14, L24, L34, L44, L54, L64, L74, L84 are biconvex lenses with positive refractive power and made of glass material, wherein the object side surfaces S18, S28, S38, S410, S58, S610, S710, S88 are convex surfaces and the image side surfaces S19, S29, S39, S411, S59, S611, S711, S89 are convex surfaces.

The fifth lenses L15, L25, L35, L45, L55, L65, L75, L85 are with negative refractive power and made of glass material, wherein the image side surfaces S111, S211, S311, S412, S511, S613, S713, S811 are concave surfaces and both of the object side surfaces S110, S210, S310, S411, S510, S612, S712, S810 and the image side surfaces S111, S211, S311, S412, S511, S613, S713, S811 are spherical surfaces.

The sixth lenses L16, L26, L36, L46, L56, L66, L76, L86 are biconvex lenses with positive refractive power and made of glass material, wherein the object side surfaces S111, S211, S312, S413, S511, S614, S713, S812 are convex surfaces and the image side surfaces S112, S212, S313, S414, S512, S615, S714, S813 are convex surfaces.

In addition, the lens assemblies 1, 2, 3, 4, 5, 6, 7, and 8 satisfy at least one of the following conditions (1)-(22):

$$200 {mm}^{2} \leq f \times tan ( FOV / 2 ) \times TTL \leq 220 {mm}^{2} ; \qquad ( 1 )$$

$$1.4 \leq CT 4 / L 4 T 2 \leq 3.2 ; \qquad ( 2 )$$

$$0.95 \leq f 4 / f \leq 3.45 ; \qquad ( 3 )$$

$$0.4 \leq Vd 2 / Vd 3 \leq 2.2 ; \qquad ( 4 )$$

$$62 \leq Vd 4 \leq 68 ; \qquad ( 5 )$$

$$2 \leq Vd 4 / Vd 5 \leq 4.1 ; \qquad ( 6 )$$

$$0.3 \leq Vd 5 / Vd 6 \leq 0.42 ; \qquad ( 7 )$$

$$3 \leq \vert R 22 - R 31 \vert \leq 80 ; \qquad ( 8 )$$

$$1.2 \leq f 3 / f \leq 6.8 ; \qquad ( 9 )$$

$$0.8 \leq Td 12 / Td 34 \leq 1.1 ; \qquad ( 10 )$$

$$25.2 \leq Td 34 / Td 45 \leq 61.8 ; \qquad ( 11 )$$

$$- 17 degree / mm \leq FOV / f 1 \leq - 4 degree / mm ; \qquad ( 12 )$$

$$- 21.5 mm \leq ( R 21 \times R 22 ) / f 2 \leq 32.5 mm ; \qquad ( 13 )$$

$$- 15 \leq ( f 1 + f 2 ) / f \leq - 3 ; \qquad ( 14 )$$

$$- 111 \leq fF / f \leq 2.2 ; \qquad ( 15 )$$

$$0.1 \leq Tz / BFL \leq 1.4 ; \qquad ( 16 )$$

$$5.9 \leq ( R 41 - R 32 ) / CT 6 \leq 15.1 ; \qquad ( 17 )$$

$$4 \leq dSI / Td 23 \leq 94 ; \qquad ( 18 )$$

$$0.05 \leq CT 2 / Td 23 \leq 13.35 ; \qquad ( 19 )$$

$$0.9 \leq CT 3 / Td 23 \leq 9.9 ; \qquad ( 20 )$$

$$0.4 \leq CT 4 / Td 23 \leq 11.8 ; \qquad ( 21 )$$

$$0.7 \leq CT 6 / Td 23 \leq 14.3 ; \qquad ( 22 )$$

wherein: f is an effective focal length of the lens assemblies 1, 2, 3, 4, 5, 6, 7, 8 for the first to eighth embodiments; f1 is an effective focal length of the first lenses L11, L21, L31, L41, L51, L61, L71, L81 for the first to eighth embodiments; f2 is an effective focal length of the second lenses L12, L22, L32, L42, L52, L62, L72, L82 for the first to eighth embodiments; f3 is an effective focal length of the third lenses L13, L23, L33, L43, L53, L63, L73, L83 for the first to eighth embodiments; f4 is an effective focal length of the fourth lenses L14, L24, L34, L44, L54, L64, L74, L84 for the first to eighth embodiments; fF is an effective focal length of a combination of the lenses L11, L12, L13, L21, L22, L23, L31, L32, L33, L41, L47, L42, L43, L51, L52, L53, L61, L67, L62, L63, L71, L77, L72, L73, L81, L82, L83 between the object side to the stops ST1, ST2, ST3, ST4, ST5, ST6, ST7, ST8 for the first to eighth embodiments; FOV is a field of view of the lens assemblies 1, 2, 3, 4, 5, 6, 7, 8 for the first to eighth embodiments; TTL is an interval from the object side surfaces S11, S21, S31, S41, S51, S61, S71, S81 of the first lenses L11, L21, L31, L41, L51, L61, L71, L81 to the image planes IMA1, IMA2, IMA3, IMA4, IMA5, IMA6, IMA7, IMA8 along the optical axes OA1, OA2, OA3, OA4, OA5, OA6, OA7, OA8 for the first to eighth embodiments; Vd2 is an Abbe number of the second lenses L12, L22, L32, L42, L52, L62, L72, L82 for the first to eighth embodiments; Vd3 is an Abbe number of the third lenses L13, L23, L33, L43, L53, L63, L73, L83 for the first to eighth embodiments; Vd4 is an Abbe number of the fourth lenses L14, L24, L34, L44, L54, L64, L74, L84 for the first to eighth embodiments; Vd5 is an Abbe number of the fifth lenses L15, L25, L35, L45, L55, L65, L75, L85 for the first to eighth embodiments; Vd6 is an Abbe number of the sixth lenses L16, L26, L36, L46, L56, L66, L76, L86 for the first to eighth embodiments; Td12 is an air interval from the image side surfaces S12, S22, S32, S42, S52, S62, S72, S82 of the first lenses L11, L21, L31, L41, L51, L61, L71, L81 to the object side surfaces S13, S23, S33, S45, S53, S65, S75, S83 of the second lenses L12, L22, L32, L42, L52, L62, L72, L82 along the optical axes OA1, OA2, OA3, OA4, OA5, OA6, OA7, OA8 for the first to eighth embodiments; Td23 is an air interval from the image side surfaces S14, S24, S34, S46, S54, S66, S76, S84 of the second lenses L12, L22, L32, L42, L52, L62, L72, L82 to the object side surfaces S15, S25, S35, S47, S55, S67, S77, S85 of the third lenses L13, L23, L33, L43, L53, L63, L73, L83 along the optical axes OA1, OA2, OA3, OA4, OA5, OA6, OA7, OA8 for the first to eighth embodiments; Td34 is an air interval from the image side surfaces S16, S26, S36, S48, S56, S68, S78, S86 of the third lenses L13, L23, L33, L43, L53, L63, L73, L83 to the object side surfaces $18, S28, S38, S410, S58, S610, S710, S88 of the fourth lenses L14, L24, L34, L44, L54, L64, L74, L84 along the optical axes OA1, OA2, OA3, OA4, OA5, OA6, OA7, OA8 for the first to eighth embodiments; Td45 is an air interval from the image side surfaces S19, S29, S39, S411, S59, S611, S711, S89 of the fourth lenses L14, L24, L34, L44, L54, L64, L74, L84 to the object side surfaces S110, S210, S310, S411, S510, S612, S712, S810 of the fifth lenses L15, L25, L35, L45, L55, L65, L75, L85 along the optical axes OA1, OA2, OA3, OA4, OA5, OA6, OA7, OA8 for the first to eighth embodiments; CT2 is an interval from the object side surfaces S13, S23, S33, S45, S53, S65, S75, S83 of the second lenses L12, L22, L32, L42, L52, L62, L72, L82 to the image side surfaces S14, S24, S34, S46, S54, S66, S76, S84 of the second lenses L12, L22, L32, L42, L52, L62, L72, L82 along the optical axes OA1, OA2, OA3, OA4, OA5, OA6, OA7, OA8 for the first to eighth embodiments; CT3 is an interval from the object side surfaces S15, S25, S35, S47, S55, S67, S77, S85 of the third lenses L13, L23, L33, L43, L53, L63, L73, L83 to the image side surfaces S16, S26, S36, S48, S56, S68, S78, S86 of the third lenses L13, L23, L33, L43, L53, L63, L73, L83 along the optical axes OA1, OA2, OA3, OA4, OA5, OA6, OA7, OA8 for the first to eighth embodiments; CT4 is an interval from the object side surfaces S18, S28, S38, S410, S58, S610, S710, S88 of the fourth lenses L14, L24, L34, L44, L54, L64, L74, L84 to the image side surfaces S19, S29, S39, S411, S59, S611, S711, S89 of the fourth lenses L14, L24, L34, L44, L54, L64, L74, L84 along the optical axes OA1, OA2, OA3, OA4, OA5, OA6, OA7, OA8 for the first to eighth embodiments; CT6 is an interval from the object side surfaces S111, S211, S312, S413, S511, S614, S713, S812 of the sixth lenses L16, L26, L36, L46, L56, L66, L76, L86 to the image side surfaces S112, S212, S313, S414, S512, S615, S714, S813 of the sixth lenses L16, L26, L36, L46, L56, L66, L76, L86 along the optical axes OA1, OA2, OA3, OA4, OA5, OA6, OA7, OA8 for the first to eighth embodiments; Tz is an interval from the object side surfaces S111, S213, S314, S413, S513, S614, S715, S812 of the lenses L16, L27, L37, L46, L57, L66, L78, L86 closest to the image side to the image side surfaces S112, S214, S315, S414, S514, S615, S716, S813 of the lenses L16, L27, L37, L46, L57, L66, L78, L86 closest to the image side along the optical axes OA1, OA2, OA3, OA4, OA5, OA6, OA7, OA8 for the first to eighth embodiments; L4T2 is an interval from the outermost edge of the object side surfaces S18, S28, S38, S410, S58, S610, S710, S88 of the fourth lenses L14, L24, L34, L44, L54, L64, L74, L84 to the outermost edge of the image side surfaces S19, S29, S39, S411, S59, S611, S711, S89 of the fourth lenses L14, L24, L34, L44, L54, L64, L74, L84 along the optical axes OA1, OA2, OA3, OA4, OA5, OA6, OA7, OA8 for the first to eighth embodiments; R21 is a radius of curvature of the object side surfaces S13, S23, S33, S45, S53, S65, S75, S83 of the second lenses L12, L22, L32, L42, L52, L62, L72, L82 for the first to eighth embodiments; R22 is a radius of curvature of the image side surfaces S14, S24, S34, S46, S54, S66, S76, S84 of the second lenses L12, L22, L32, L42, L52, L62, L72, L82 for the first to eighth embodiments; R31 is a radius of curvature of the object side surfaces S15, S25, S35, S47, S55, S67, S77, S85 of the third lenses L13, L23, L33, L43, L53, L63, L73, L83 for the first to eighth embodiments; R32 is a radius of curvature of the image side surfaces S16, S26, S36, S48, S56, S68, S78, S86 of the third lenses L13, L23, L33, L43, L53, L63, L73, L83 for the first to eighth embodiments; R41 is a radius of curvature of the object side surfaces S18, S28, S38, S410, S58, S610, S710, S88 of the fourth lenses L14, L24, L34, L44, L54, L64, L74, L84 for the first to eighth embodiments; dSI is an interval from the stops ST1, ST2, ST3, ST4, ST5, ST6, ST7, ST8 to the image planes IMA1, IMA2, IMA3, IMA4, IMA5, IMA6, IMA7, IMA8 along the optical axes OA1, OA2, OA3, OA4, OA5, OA6, OA7, OA8 for the first to eighth embodiments; and BFL is an interval from the image side surfaces S112, S214, S315, S414, S514, S615, S716, S813 of the lenses L16, L27, L37, L46, L57, L66, L78, L86 closest to the image side to the image planes IMA1, IMA2, IMA3, IMA4, IMA5, IMA6, IMA7, IMA8 along the optical axes OA1, OA2, OA3, OA4, OA5, OA6, OA7, OA8 for the first to eighth embodiments. With the lens assemblies 1, 2, 3, 4, 5, 6, 7, 8 satisfying at least one of the above conditions (1)-(22), the F-number can be effectively decreased, the resolution can be effectively increased, the aberration can be effectively corrected, and the chromatic aberration can be effectively corrected.

When the condition (1): 200 mm²≤f×tan(FOV/2)×TTL≤220 mm² is satisfied, the distortion can be corrected effectively. When the condition (2): 1.4≤CT4/L4T2≤3.2 is satisfied, the cost of the lens processing can be decreased effectively. When the condition (3): 0.95≤f4/f≤3.45 is satisfied, the sensitivity of the fourth lens can be controlled effectively. When the condition (4): 0.4≤Vd2/Vd3≤2.2 is satisfied, the lateral color can be corrected effectively. When the condition (5): 62≤Vd4≤68 is satisfied, the lateral color can be corrected effectively. When the condition (6): 2≤Vd4/Vd5≤4.1 is satisfied, the lateral color can be corrected effectively. When the condition (7): 0.3≤Vd5/Vd6≤0.42 is satisfied, the lateral color can be corrected effectively. When the condition (8): 3 mm≤|R22−R31|≤80 mm is satisfied, the sensitivity of the air interval between the second lens and the third lens can be controlled effectively. When the condition (9): 1.2≤f3/f≤6.8 is satisfied, the sensitivity of the third lens can be controlled effectively. When the condition (10): 0.8≤Td12/Td34≤1.1 is satisfied, the field curvature can be corrected effectively. When the condition (11): 25.2≤Td34/Td45≤61.8 is satisfied, the field curvature can be corrected effectively. When the condition (12): −17 degree/mm≤FOV/f1≤−4 degree/mm is satisfied, the refractive power of the first lens can avoid too large, which is conducive to the production of the first lens. When the condition (13): −21.5 mm≤(R21×R22)/f2≤32.5 mm is satisfied, the production yield of the second lens can be increased effectively and the manufacturing cost can be decreased. When the condition (14): −15≤(f1+f2)/f≤−3 is satisfied, the manufacturing sensitivity can decreased effectively and improve image quality. When the condition (15): −111≤fF/f≤2.2 is satisfied, the relative illumination of the lens assembly can be increased effectively. When the condition (16): 0.1≤Tz/BFL≤1.4 is satisfied, the back focal length can be increased effectively and conducive to the production of the lens assembly. When the condition (17): 5.9≤(R41-R32)/CT6≤15.1 is satisfied, the impact of the lens thickness error on image quality can be decreased effectively. When the condition (18): 4≤dSI/Td23≤94 is satisfied, the impact of the lens thickness error on image quality can be decreased effectively. When the condition (19): 0.05≤CT2/Td23≤13.35 is satisfied, the impact of the lens thickness error on image quality can be decreased effectively. When the condition (20): 0.9≤CT3/Td23≤9.9 is satisfied, the impact of the lens thickness error on image quality can be decreased effectively. When the condition (21): 0.4≤CT4/Td23≤11.8 is satisfied, the impact of the lens thickness error on image quality can be decreased effectively. When the condition (22): 0.7≤CT6/Td23≤14.3 is satisfied, the impact of the lens thickness error on image quality can be decreased effectively.

A detailed description of a lens assembly in accordance with a first embodiment of the invention is as follows. Referring to FIG. 1, the lens assembly 1 includes a first lens L11, a second lens L12, a third lens L13, a stop ST1, a fourth lens L14, a fifth lens L15, a sixth lens L16, an optical filter OF1, and a cover glass CG1, all of which are arranged in order from an object side to an image side along an optical axis OA1. In operation, the light from the object side is imaged on an image plane IMA1.

According to the foregoing, wherein: both of the object side surface S11 and image side surface S12 of the first lens L11 are spherical surfaces; the second lens L12 is a meniscus lens, wherein the object side surface S13 is a concave surface and the image side surface S14 is a convex surface; the third lens L13 is a meniscus lens, wherein the object side surface S15 is a concave surface and both of the object side surface S15 and image side surface S16 are spherical surfaces; both of the object side surface S18 and image side surface S19 of the fourth lens L14 are aspheric surfaces; the fifth lens L15 is a biconcave lens, wherein the object side surface S110 is concave surface; both of the object side surface S111 and image side surface S112 of the sixth lens L16 are spherical surfaces; the fifth lens L15 is cemented with the sixth lens L16; both of object side surface S113 and image side surface S114 of the optical filter OF1 are plane surfaces; and both of the object side surface S115 and image side surface S116 of the cover glass CG1 are plane surfaces.

With the above design of the lenses, stop ST1, and at least one of the conditions (1)-(22) satisfied, the lens assembly 1 can have an effective decreased F-number, an effective increased resolution, an effective corrected aberration, and an effective corrected chromatic aberration.

Table 1 shows the optical specification of the lens assembly 1 in FIG. 1.

TABLE 1
Effective Focal Length = 7.97 mm
F-number = 1.76
Total Lens Length = 35.25 mm
Field of View = 75.29 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S11 | 14.08 | 2.31 | 1.5927 | 35.4456 | −13.185 | L11 |
| S12 | 4.75 | 4.89 | | | | |
| S13 | −6.24 | 0.45 | 1.51823 | 58.9609 | −15.247 | L12 |
| S14 | −29.75 | 0.30 | | | | |
| S15 | −70.03 | 2.86 | 1.95375 | 32.3188 | 12.5468 | L13 |
| S16 | −10.52 | 5.14 | | | | |
| S17 | ∞ | 0.03 | | | | ST1 |
| S18 | 13.42 | 2.45 | 1.61921 | 63.8548 | 9.6071 | L14 |
| S19 | −10.03 | 0.19 | | | | |
| S110 | −18.10 | 1.30 | 1.77047 | 29.7357 | −8.4126 | L15 |
| S111 | 10.61 | 2.83 | 1.55032 | 75.4963 | 10.7523 | L16 |
| S112 | −12.24 | 10.72 | | | | |
| S113 | ∞ | 2.20 | | | | OF1 |
| S114 | ∞ | 0.30 | 1.5163 | 64.048 | | |
| S115 | ∞ | 1.59 | | | | CG1 |
| S116 | ∞ | 0.50 | 1.5163 | 64.048 | | |

In the first embodiment, the conic constant k and the aspheric coefficients A, B, C, D, E, F, G of each aspheric lens are shown in Table 2.

TABLE 2

| Surface | | A | B | C | |
|---|---|---|---|---|---|
| Number | k | E | F | G | D |
| S18 | 0 | −9.81E−05 | −2.99E−07 | 1.40E−08 | −5.51E−10 |
| | | 7.60E−11 | −1.83E−12 | −6.67E−14 | |
| S19 | 0 | 3.28E−04 | 1.10E−07 | −1.16E−07 | 5.72E−09 |
| | | 4.79E−11 | −7.62E−12 | 5.53E−14 | |

Table 3 shows the parameters and condition values for conditions (1)-(22) in accordance with the first embodiment of the invention. It can be seen from Table 3 that the lens assembly 1 of the first embodiment satisfies the conditions (1)-(22).

TABLE 3

| | | | | | |
|---|---|---|---|---|---|
| CT6 | 2.83 | CT4 | 2.45 | L4T2 | 0.77 |
| | mm | | mm | | mm |
| Td12 | 4.89 | Td23 | 0.30 | Td34 | 5.17 |
| | mm | | mm | | mm |
| Td45 | 0.19 | fF | −36.71 | Tz | 2.83 |
| | mm | | mm | | mm |
| BFL | 12.50 | dSI | 19.30 | CT2 | 0.45 |
| | mm | | | | mm |
| CT3 | 2.86 | | | | |
| | mm | | | | |
| f × tan(FOV/2) × TTL | 216.65 | CT4/L4T2 | 3.17 | f4/f | 1.21 |
| | mm² | | | | |
| Vd2/Vd3 | 1.82 | Vd4 | 63.85 | Vd4/Vd5 | 2.15 |
| Vd5/Vd6 | 0.39 | \|R22 − R31\| | 40.28 | f3/f | 1.57 |
| | | | mm | | |
| Td12/Td34 | 0.95 | Td34/Td45 | 26.92 | FOV/f1 | −5.71 |
| | | | | | degree/mm |
| (R21 × R22)/f2 | −12.17 | (f1 + f2)/f | −3.57 | fF/f | −4.60 |
| | mm | | | | |
| Tz/BFL | 0.23 | (R41 − R32)/CT6 | 8.47 | dSI/Td23 | 64.33 |
| CT2/Td23 | 1.49 | CT3/Td23 | 9.53 | CT4/Td23 | 8.17 |
| CT6/Td23 | 9.42 | | | | |

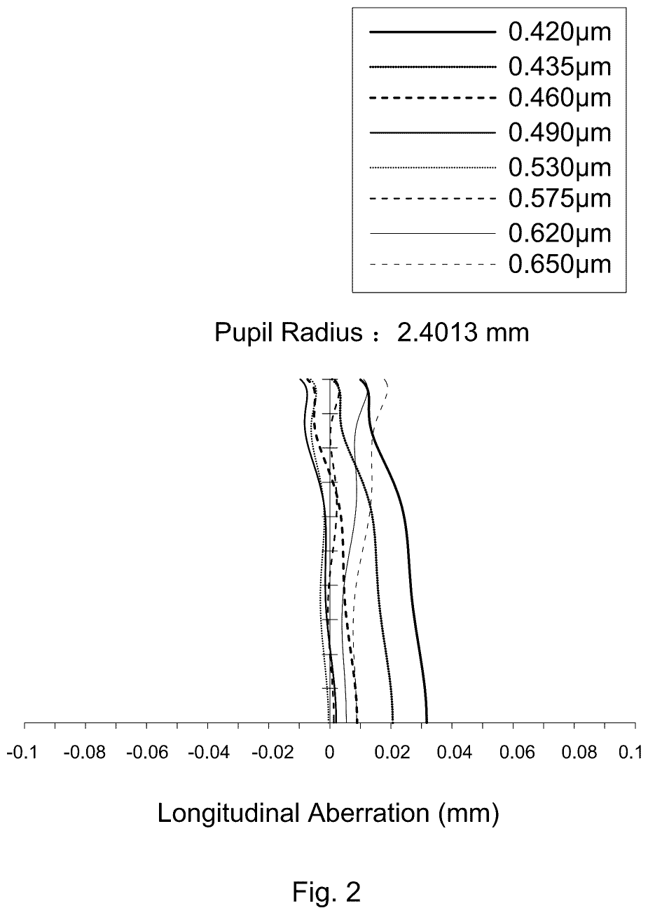

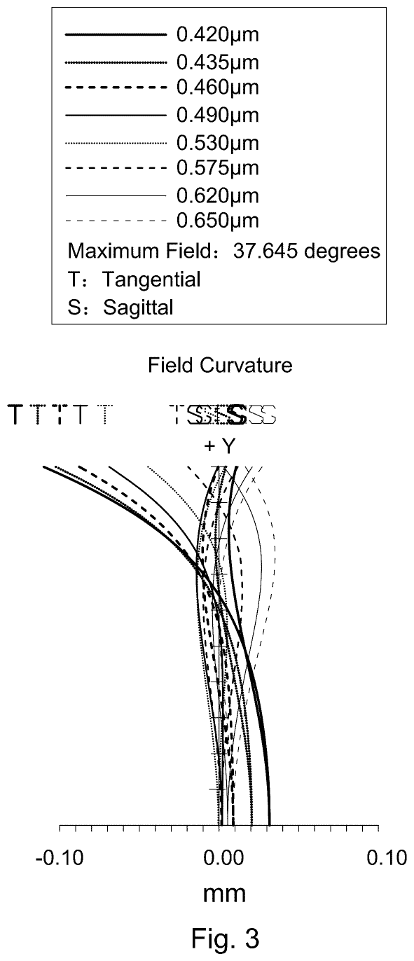

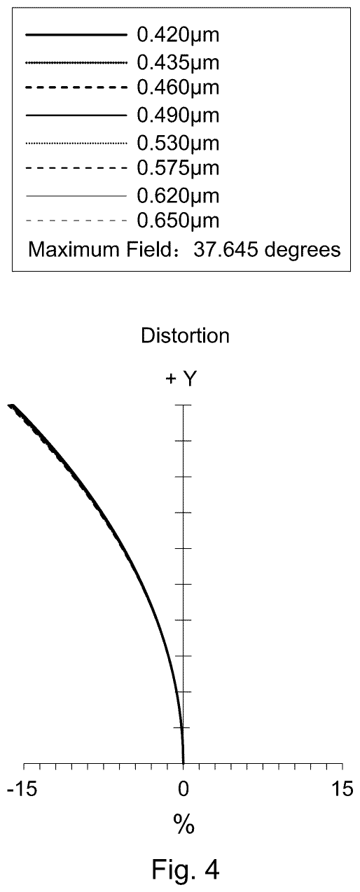

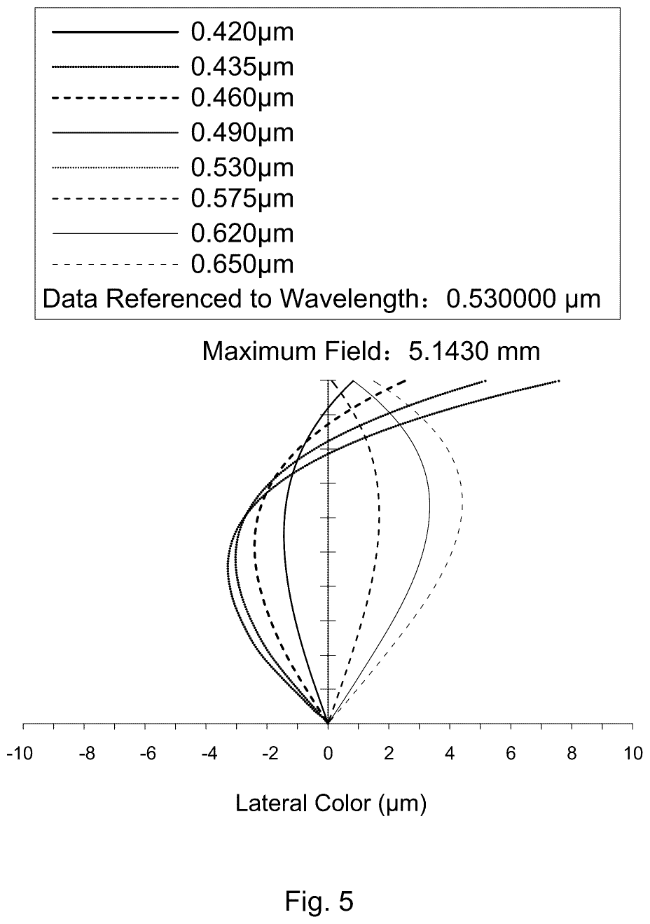

In addition, the lens assembly 1 of the first embodiment can meet the requirements of optical performance as seen in FIGS. 2-5. It can be seen from FIG. 2 that the longitudinal aberration in the lens assembly 1 of the first embodiment ranges from −0.01 mm to 0.04 mm. It can be seen from FIG. 3 that the field curvature of tangential direction and sagittal direction in the lens assembly 1 of the first embodiment ranges from −0.12 mm to 0.04 mm. It can be seen from FIG. 4 that the distortion in the lens assembly 1 of the first embodiment ranges from −18% to 0%. It can be seen from FIG. 5 that the lateral color in the lens assembly 1 of the first embodiment ranges from −4 μm to 8 μm. It is obvious that the longitudinal aberration, the field curvature, the distortion, and the lateral color of the lens assembly 1 of the first embodiment can be corrected effectively. Therefore, the lens assembly 1 of the first embodiment is capable of good optical performance.

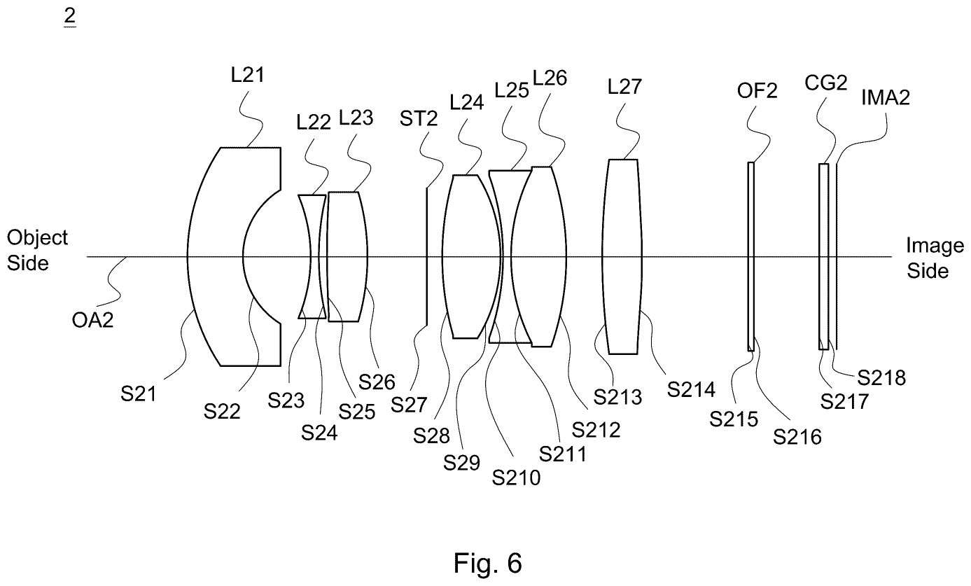

A detailed description of a lens assembly in accordance with a second embodiment of the invention is as follows. Referring to FIG. 6, the lens assembly 2 includes a first lens L21, a second lens L22, a third lens L23, a stop ST2, a fourth lens L24, a fifth lens L25, a sixth lens L26, a seventh lens L27, an optical filter OF2, and a cover glass CG2, all of which are arranged in order from an object side to an image side along an optical axis OA2. In operation, the light from the object side is imaged on an image plane IMA2.

According to the foregoing, wherein: both of the object side surface S21 and image side surface S22 of the first lens L21 are spherical surfaces; the second lens L22 is a biconcave lens, wherein the object side surface S23 is a concave surface and the image side surface S24 is a concave surface; the third lens L23 is a biconvex lens, wherein the object side surface S25 is a convex surface and both of the object side surface S25 and image side surface S26 are spherical surfaces; both of the object side surface S28 and image side surface S29 of the fourth lens L24 are aspheric surfaces; the fifth lens L25 is a biconcave lens, wherein the object side surface S210 is concave surface; both of the object side surface S211 and image side surface S212 of the sixth lens L26 are spherical surfaces; the fifth lens L25 is cemented with the sixth lens L26; the seventh lens L27 is a biconvex lens with positive refractive power and made of glass material, wherein the object side surface S213 is a convex surface, the image side surface S214 is a convex surface, and both of the object side surface S213 and image side surface S214 are aspheric surfaces; both of object side surface S215 and image side surface S216 of the optical filter OF2 are plane surfaces; and both of the object side surface S217 and image side surface S218 of the cover glass CG2 are plane surfaces.

With the above design of the lenses, stop ST2, and at least one of the conditions (1)-(22) satisfied, the lens assembly 2 can have an effective decreased F-number, an effective increased resolution, an effective corrected aberration, and an effective corrected chromatic aberration.

Table 4 shows the optical specification of the lens assembly 2 in FIG. 6.

TABLE 4
Effective Focal Length = 7.98 mm
F-number = 1.81
Total Lens Length = 35.24 mm
Field of View = 74.19 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S21 | 11.19 | 2.99 | 1.61997 | 63.88 | -14.114 | L21 |
| S22 | 4.42 | 3.71 | | | | |
| S23 | −9.03 | 0.45 | 1.51823 | 58.9609 | −11.064 | L22 |
| S24 | 16.23 | 0.44 | | | | |
| S25 | 80.21 | 2.19 | 1.95375 | 32.313 | 11.6925 | L23 |
| S26 | −12.94 | 3.22 | | | | |
| S27 | ∞ | 0.84 | | | | ST2 |
| S28 | 16.75 | 3.15 | 1.61649 | 62.91 | 9.37851 | L24 |
| S29 | −8.26 | 0.14 | | | | |
| S210 | −13.97 | 0.43 | 1.71736 | 29.5008 | −8.3591 | L25 |
| S211 | 10.86 | 3.02 | 1.55032 | 75.4963 | 12.0147 | L26 |
| S212 | −15.41 | 1.93 | | | | |
| S213 | 36.99 | 2.14 | 1.72902 | 48.41 | 30.1513 | L27 |
| S214 | −53.77 | 5.79 | | | | |
| S215 | ∞ | 0.30 | 1.5168 | 64.1673 | | OF2 |
| S216 | ∞ | 3.56 | | | | |
| S217 | ∞ | 0.50 | 1.5168 | 64.1673 | | CG2 |
| S218 | ∞ | 0.44 | | | | |

In the second embodiment, the conic constant k and the aspheric coefficients A, B, C, D, E, F, G of each aspheric lens are shown in Table 5.

TABLE 5

| Surface | | A | B | C | |
|---|---|---|---|---|---|
| Number | k | E | F | G | D |
| S28 | 0 | −1.19E−04 | 5.69E−06 | −1.32E−07 | −3.05E−09 |
| | | 2.01E−10 | 1.76E−11 | −5.56E−13 | |
| S29 | 0 | 1.13E−04 | 7.55E−06 | −3.40E−08 | −2.47E−10 |
| | | 3.12E−11 | 2.72E−12 | 6.78E−14 | |
| S213 | 0 | −1.78E−04 | 4.32E−06 | 2.45E−08 | −1.21E−09 |
| | | 1.04E−10 | −2.05E−12 | −3.17E−15 | |
| S214 | 0 | −8.23E−05 | 2.47E−06 | 7.24E−08 | −2.97E−10 |
| | | 5.42E−12 | 7.53E−13 | −3.06E−14 | |

Table 6 shows the parameters and condition values for conditions (1)-(22) in accordance with the second embodiment of the invention. It can be seen from Table 6 that the lens assembly 2 of the second embodiment satisfies the conditions (1)-(22).

TABLE 6

| | | | | | |
|---|---|---|---|---|---|
| CT6 | 3.02 | CT4 | 3.15 | L4T2 | 1.33 |
| | mm | | mm | | mm |
| Td12 | 3.71 | Td23 | 0.44 | Td34 | 4.06 |
| | mm | | mm | | mm |
| Td45 | 0.14 | fF | −19.12 | Tz | 2.14 |
| | mm | | mm | | mm |
| BFL | 10.58 | dSI | 22.23 | CT2 | 0.45 |
| | mm | | mm | | mm |
| CT3 | 2.19 | | | | |
| | mm | | | | |
| f × tan(FOV/2) × TTL | 212.47 | CT4/L4T2 | 2.37 | f4/f | 1.18 |
| | mm² | | | | |
| Vd2/Vd3 | 1.82 | Vd4 | 62.91 | Vd4/Vd5 | 2.13 |
| Vd5/Vd6 | 0.39 | \|R22 − R31\| | 63.98 | f3/f | 1.47 |
| | | | mm | | |
| Td12/Td34 | 0.91 | Td34/Td45 | 29.64 | FOV/f1 | −5.26 |
| | | | | | degree/mm |
| (R21 × R22)/f2 | 13.25 | (f1 + f2)/f | −3.16 | fF/f | —2.40 |
| | mm | | | | |
| Tz/BFL | 0.20 | (R41 − R32)/CT6 | 9.82 | dSI/Td23 | 50.52 |
| CT2/Td23 | 1.03 | CT3/Td23 | 4.96 | CT4/Td23 | 7.13 |
| CT6/Td23 | 6.84 | | | | |

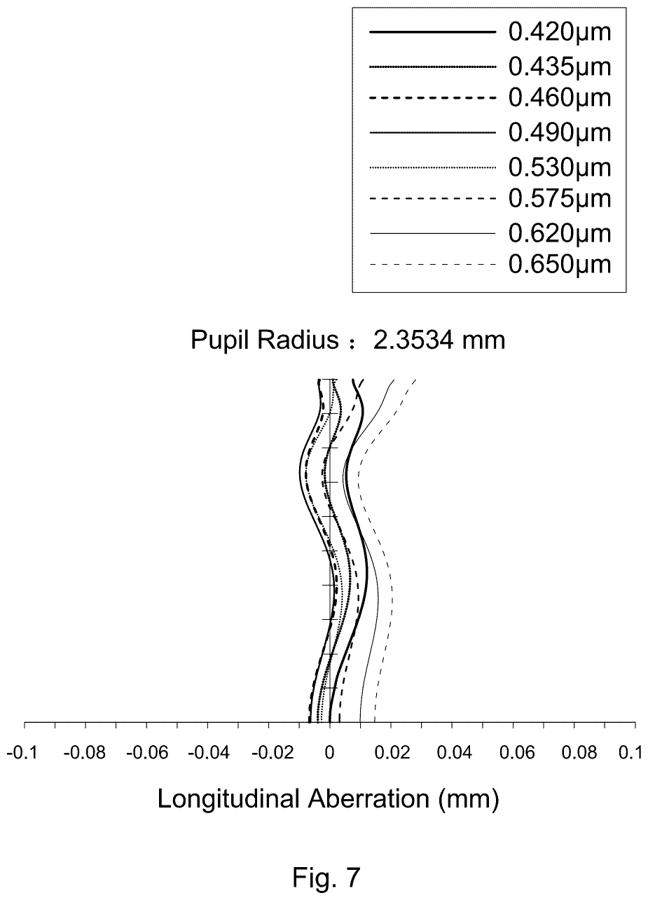

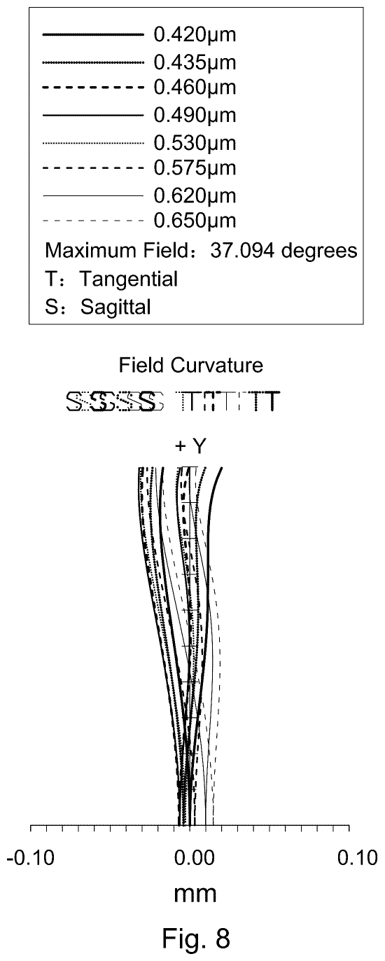

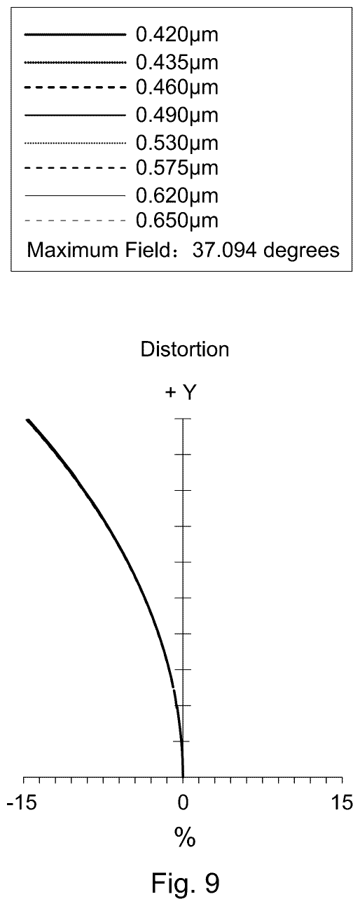

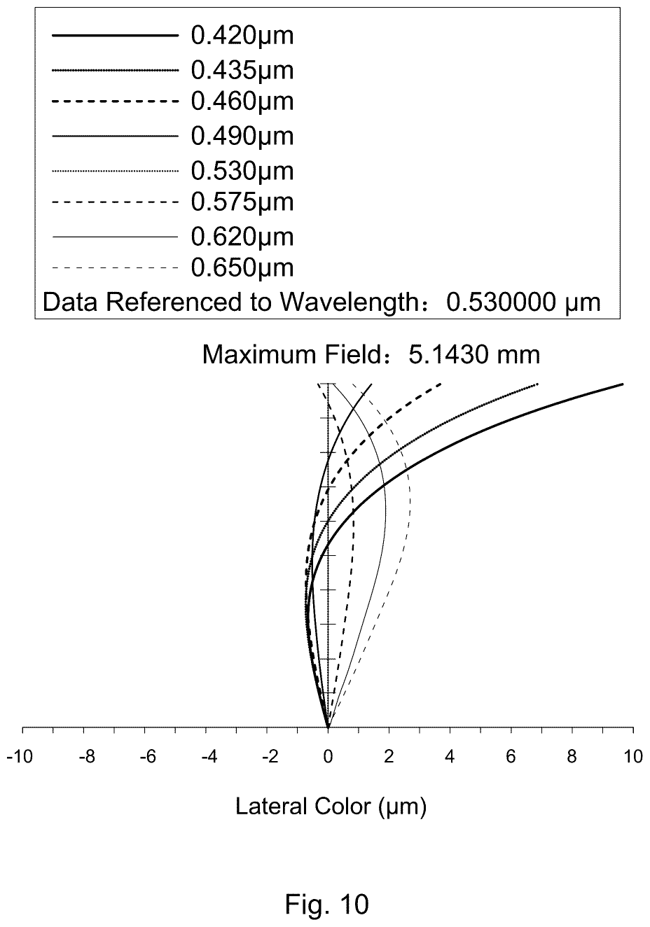

In addition, the lens assembly 2 of the second embodiment can meet the requirements of optical performance as seen in FIGS. 7-10. It can be seen from FIG. 7 that the longitudinal aberration in the lens assembly 2 of the second embodiment ranges from −0.01 mm to 0.03 mm. It can be seen from FIG. 8 that the field curvature of tangential direction and sagittal direction in the lens assembly 2 of the second embodiment ranges from −0.04 mm to 0.02 mm. It can be seen from FIG. 9 that the distortion in the lens assembly 2 of the second embodiment ranges from −15% to 0%. It can be seen from FIG. 10 that the lateral color in the lens assembly 2 of the second embodiment ranges from −1 μm to 10 μm. It is obvious that the longitudinal aberration, the field curvature, the distortion, and the lateral color of the lens assembly 2 of the second embodiment can be corrected effectively. Therefore, the lens assembly 2 of the second embodiment is capable of good optical performance.

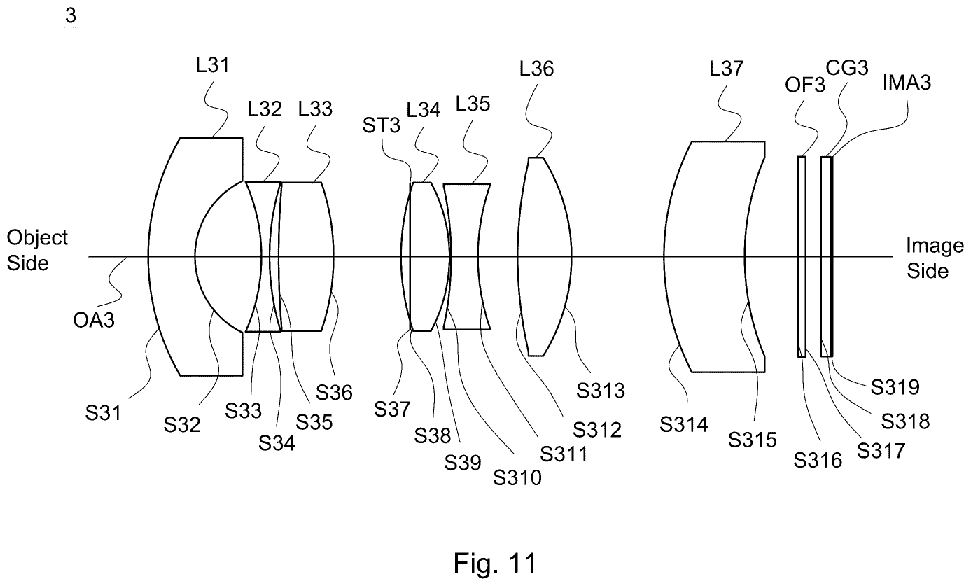

A detailed description of a lens assembly in accordance with a third embodiment of the invention is as follows. Referring to FIG. 11, the lens assembly 3 includes a first lens L31, a second lens L32, a third lens L33, a stop ST3, a fourth lens L34, a fifth lens L35, a sixth lens L36, a seventh lens L37, an optical filter OF3, and a cover glass CG3, all of which are arranged in order from an object side to an image side along an optical axis OA3. In operation, the light from the object side is imaged on an image plane IMA3.

According to the foregoing, wherein: both of the object side surface S31 and image side surface S32 of the first lens L31 are spherical surfaces; the second lens L32 is a biconcave lens, wherein the object side surface S33 is a concave surface and the image side surface S34 is a concave surface; the third lens L33 is a biconvex lens, wherein the object side surface S35 is a convex surface and both of the object side surface S35 and image side surface S36 are spherical surfaces; both of the object side surface S38 and image side surface S39 of the fourth lens L34 are aspheric surfaces; the fifth lens L35 is a biconcave lens, wherein the object side surface S310 is concave surface; both of the object side surface S312 and image side surface S313 of the sixth lens L36 are spherical surfaces; the seventh lens L37 is a meniscus lens with positive refractive power and made of glass material, wherein the object side surface S314 is a convex surface, the image side surface S315 is a concave surface, and both of the object side surface S314 and image side surface S315 are spherical surfaces; both of object side surface S316 and image side surface S317 of the optical filter OF3 are plane surfaces; and both of the object side surface S318 and image side surface S319 of the cover glass CG3 are plane surfaces.

With the above design of the lenses, stop ST3, and at least one of the conditions (1)-(22) satisfied, the lens assembly 3 can have an effective decreased F-number, an effective increased resolution, an effective corrected aberration, and an effective corrected chromatic aberration.

Table 7 shows the optical specification of the lens assembly 3 in FIG. 11.

TABLE 7
Effective Focal Length = 7.97 mm
F-number = 1.75
Total Lens Length = 35.11 mm
Field of View = 75.05 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S31 | 12.28 | 2.46 | 1.48749 | 70.4412 | −15.705 | L31 |
| S32 | 4.42 | 3.39 | | | | |
| S33 | −9.40 | 0.39 | 1.51823 | 58.9609 | −10.506 | L32 |
| S34 | 13.32 | 0.45 | | | | |
| S35 | 40.99 | 2.81 | 2.001 | 29.1347 | 9.62913 | L33 |
| S36 | −12.36 | 3.94 | | | | |
| S37 | ∞ | −0.45 | | | | ST3 |
| S38 | 11.61 | 2.51 | 1.59419 | 67.2954 | 7.83518 | L34 |
| S39 | −7.21 | 0.06 | | | | |
| S310 | −17.51 | 1.36 | 1.85451 | 25.1547 | −7.6966 | L35 |
| S311 | 11.15 | 2.07 | | | | |
| S312 | 22.76 | 2.73 | 1.4971 | 81.5596 | 14.1966 | L36 |
| S313 | −9.88 | 4.74 | | | | |
| S314 | 13.02 | 4.19 | 2.0509 | 26.9424 | 57.6254 | L37 |
| S315 | 13.79 | 2.70 | | | | |
| S316 | ∞ | 0.40 | 1.5168 | 64.1673 | | OF3 |
| S317 | ∞ | 0.80 | | | | |
| S318 | ∞ | 0.50 | 1.5168 | 64.1673 | | CG3 |
| S319 | ∞ | 0.08 | | | | |

In the third embodiment, the conic constant k and the aspheric coefficients A, B, C, D, E, F, G of each aspheric lens are shown in Table 8.

TABLE 8

| Surface | | A | B | C | |
|---|---|---|---|---|---|
| Number | k | E | F | G | D |
| S38 | 0 | −1.62E−04 | 2.13E−06 | −1.96E−07 | −7.70E−09 |
| | | 3.49E−10 | 3.05E−11 | −3.37E−12 | |
| S39 | 0 | 6.27E−04 | −2.32E−06 | 7.78E−08 | 8.81E−09 |
| | | −3.29E−10 | −4.72E−11 | 6.58E−13 | |

Table 9 shows the parameters and condition values for conditions (1)-(22) in accordance with the third embodiment of the invention. It can be seen from Table 9 that the lens assembly 3 of the third embodiment satisfies the conditions (1)-(22).

TABLE 6

| | | | | | |
|---|---|---|---|---|---|
| CT6 | 2.73 | CT4 | 2.51 | L4T2 | 0.92 |
| | mm | | mm | | mm |
| Td12 | 3.39 | Td23 | 0.45 | Td34 | 3.49 |
| | mm | | mm | | mm |
| Td45 | 0.06 | fF | −43.68 | Tz | 4.19 |
| | mm | | mm | | mm |
| BFL | 4.48 | dSI | 21.66 | CT2 | 0.39 |
| | mm | | mm | | mm |
| CT3 | 2.81 | | | | |
| | mm | | | | |
| f × tan(FOV/2) × TTL | 214.77 | CT4/L4T2 | 2.71 | f4/f | 0.98 |
| | mm² | | | | |
| Vd2/Vd3 | 2.02 | Vd4 | 67.30 | Vd4/Vd5 | 2.68 |
| Vd5/Vd6 | 0.31 | \|R22 − R31\| | 27.67 | f3/f | 1.21 |
| | | | mm | | |
| Td12/Td34 | 0.97 | Td34/Td45 | 60.17 | FOV/f1 | −4.78 |
| | | | | | degree/mm |
| (R21 × R22)/f2 | 11.91 | (f1 + f2)/f | −3.29 | fF/f | −5.48 |
| | mm | | | | |
| Tz/BFL | 0.94 | (R41 − R32)/CT6 | 8.79 | dSI/Td23 | 48.13 |
| CT2/Td23 | 0.87 | CT3/Td23 | 6.24 | CT4/Td23 | 5.55 |
| CT6/Td23 | 6.05 | | | | |

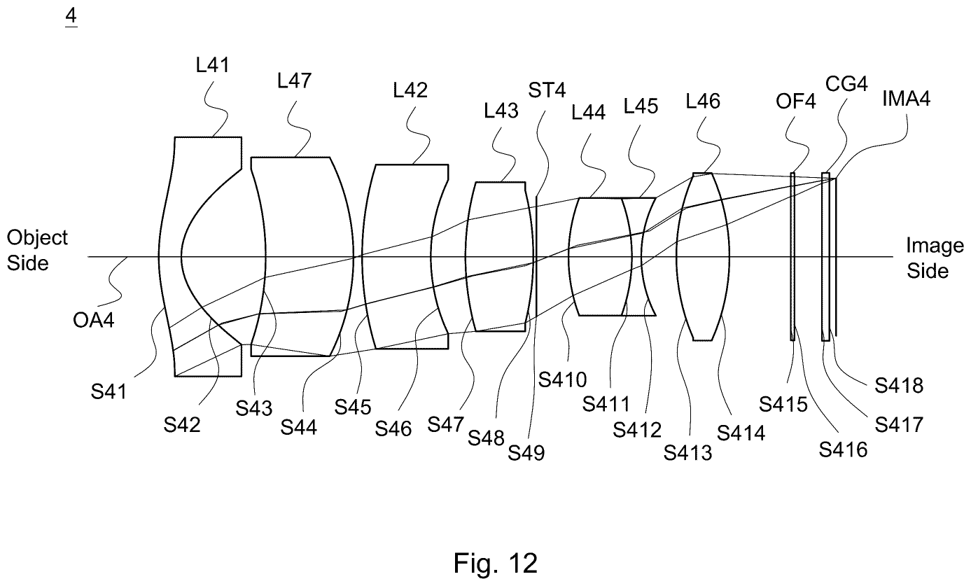

A detailed description of a lens assembly in accordance with a fourth embodiment of the invention is as follows. Referring to FIG. 12, the lens assembly 4 includes a first lens L41, a seventh lens L47, a second lens L42, a third lens L43, a stop ST4, a fourth lens L44, a fifth lens L45, a sixth lens L46, an optical filter OF4, and a cover glass CG4, all of which are arranged in order from an object side to an image side along an optical axis OA4. In operation, the light from the object side is imaged on an image plane IMA4.

According to the foregoing, wherein: both of the object side surface S41 and image side surface S42 of the first lens L41 are aspheric surfaces; the second lens L42 is a meniscus lens, wherein the object side surface S45 is a convex surface and the image side surface S46 is a concave surface; the third lens L43 is a biconvex lens, wherein the object side surface S47 is a convex surface and both of the object side surface S47 and image side surface S48 are spherical surfaces; both of the object side surface S410 and image side surface S411 of the fourth lens L44 are spherical surfaces; the fifth lens L45 is a biconcave lens, wherein the object side surface S411 is concave surface; the fourth lens L44 is cemented with the fifth lens L45; both of the object side surface S413 and image side surface S414 of the sixth lens L46 are aspheric surfaces; the seventh lens L47 is a meniscus lens with positive refractive power and made of glass material, wherein the object side surface S43 is a concave surface, the image side surface S44 is a convex surface, and both of the object side surface S43 and image side surface S44 are spherical surfaces; both of object side surface S415 and image side surface S416 of the optical filter OF4 are plane surfaces; and both of the object side surface S417 and image side surface S418 of the cover glass CG4 are plane surfaces.

With the above design of the lenses, stop ST4, and at least one of the conditions (2)-(4), (6)-(9), (12)-(22) satisfied, the lens assembly 4 can have an effective decreased F-number, an effective increased resolution, an effective corrected aberration, and an effective corrected chromatic aberration.

Table 10 shows the optical specification of the lens assembly 4 in FIG. 12.

TABLE 10
Effective Focal Length = 5.70 mm
F-number = 1.80
Total Lens Length = 44.62 mm
Field of View = 98.80 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S41 | 11.64 | 1.49 | 1.77 | 49.5 | −8.862 | L41 |
| S42 | 4.07 | 5.56 | | | | |
| S43 | −17.66 | 5.81 | 1.81 | 41 | 49.274 | L47 |
| S44 | −14.07 | 0.54 | | | | |
| S45 | 20.52 | 4.58 | 1.52 | 64.2 | −71.899 | L42 |
| S46 | 12.23 | 2.23 | | | | |
| S47 | 17.92 | 4.47 | 1.73 | 54.7 | 12.893 | L43 |
| S48 | −17.92 | 0.20 | | | | |
| S49 | ∞ | 2.11 | | | | ST4 |
| S410 | 10.81 | 4.20 | 1.57 | 71.3 | 10.174 | L44 |
| S411 | −10.81 | 0.60 | 1.74 | 27.8 | −6.144 | L45 |
| S412 | 8.22 | 2.32 | | | | |
| S413 | 12.37 | 3.50 | 1.59 | 67 | 10.88 | L46 |
| S414 | −12.05 | 4.00 | | | | |
| S415 | ∞ | 0.30 | 1.52 | 64.2 | | OF4 |
| S416 | ∞ | 1.77 | | | | |
| S417 | ∞ | 0.50 | 1.52 | 64.2 | | CG4 |
| S418 | ∞ | 0.44 | | | | |

In the fourth embodiment, the conic constant k and the aspheric coefficients A, B, C, D, E, F, G of each aspheric lens are shown in Table 11.

TABLE 11

| Surface | | | | | | | | |
|---|---|---|---|---|---|---|---|---|
| Number | k | A | B | C | D | E | F | G |
| S41 | −1.32 | −5.64E−04 | 3.37E−06 | −1.02E−08 | 0 | 0 | 0 | 0 |
| S42 | −1.00 | 9.12E−05 | −5.45E−06 | −1.80E−08 | 0 | 0 | 0 | 0 |
| S413 | −1.50 | −1.99E−05 | 1.61E−06 | −6.28E−08 | 0 | 0 | 0 | 0 |
| S414 | −8.42 | −3.04E−04 | 6.20E−06 | −1.50E−07 | 0 | 0 | 0 | 0 |

Table 12 shows the parameters and condition values for conditions (2)-(4), (6)-(9), (12)-(22) in accordance with the fourth embodiment of the invention. It can be seen from Table 12 that the lens assembly 4 of the fourth embodiment satisfies the conditions (2)-(4), (6)-(9), (12)-(22).

TABLE 12

| | | | | | |
|---|---|---|---|---|---|
| CT4 | 4.20 | L4T2 | 2.80 | Td23 | 2.23 |
| | mm | | mm | | mm |
| fF | 9.95 | Tz | 3.50 | BFL | 7.01 |
| | mm | | mm | | mm |
| dSI | 19.74 | CT2 | 4.58 | CT3 | 4.47 |
| | mm | | mm | | mm |
| CT6 | 3.50 | | | | |
| | mm | | | | |
| CT4/L4T2 | 1.50 | f4/f | 1.78 | Vd2/Vd3 | 1.17 |
| Vd4/Vd5 | 2.56 | Vd5/Vd6 | 0.41 | \|R22 − R31\| | 5.69 |
| | | | | | mm |
| f3/f | 2.26 | FOV/f1 | −11.1 | (R21 × R22)/f2 | −3.49 |
| | | | degree/mm | | mm |
| (f1 + f2)/f | −14.17 | fF/f | 1.74 | Tz/BFL | 0.50 |
| (R41 − R32)/CT6 | 8.21 | dSI/Td23 | 8.85 | CT2/Td23 | 2.05 |
| CT3/Td23 | 2.00 | CT4/Td23 | 1.88 | CT6/Td23 | 1.57 |

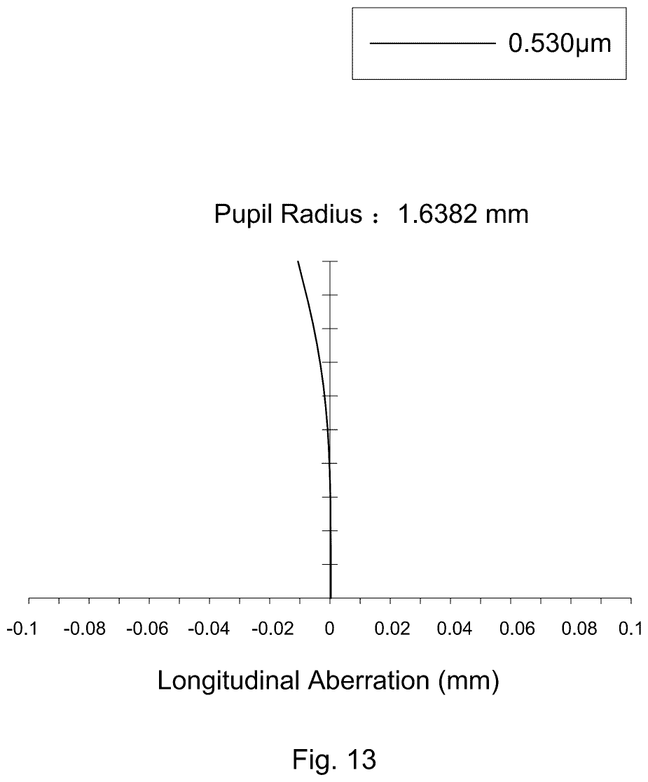

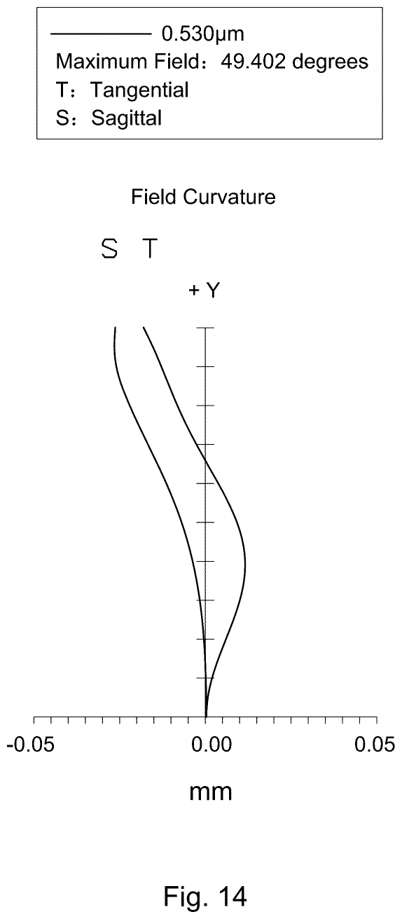

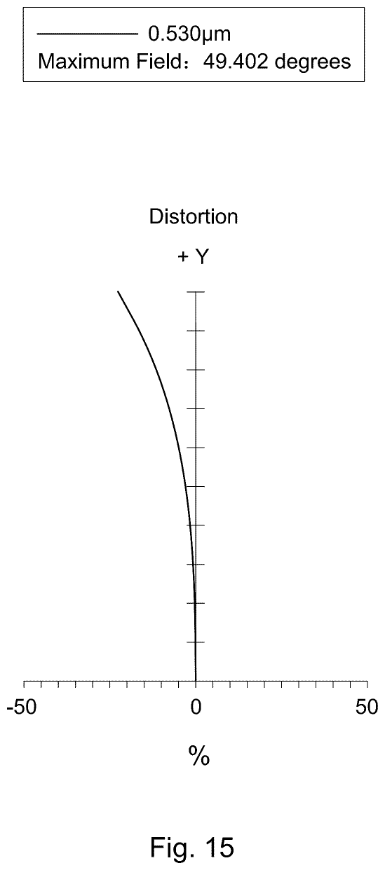

In addition, the lens assembly 4 of the fourth embodiment can meet the requirements of optical performance as seen in FIGS. 13-15. It can be seen from FIG. 13 that the longitudinal aberration in the lens assembly 4 of the fourth embodiment ranges from −0.01 mm to 0.0 mm. It can be seen from FIG. 14 that the field curvature of tangential direction and sagittal direction in the lens assembly 4 of the fourth embodiment ranges from −0.03 mm to 0.02 mm. It can be seen from FIG. 15 that the distortion in the lens assembly 4 of the fourth embodiment ranges from −25% to 0%. It is obvious that the longitudinal aberration, the field curvature, and the distortion of the lens assembly 4 of the fourth embodiment can be corrected effectively. Therefore, the lens assembly 4 of the fourth embodiment is capable of good optical performance.

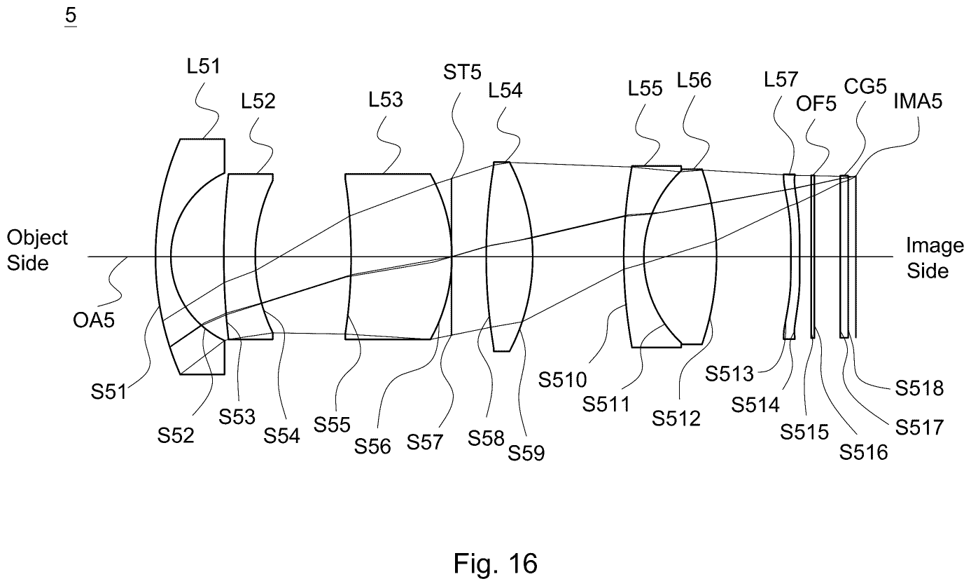

A detailed description of a lens assembly in accordance with a fifth embodiment of the invention is as follows. Referring to FIG. 16, the lens assembly 5 includes a first lens L51, a second lens L52, a third lens L53, a stop ST5, a fourth lens L54, a fifth lens L55, a sixth lens L56, a seventh lens L57, an optical filter OF5, and a cover glass CG5, all of which are arranged in order from an object side to an image side along an optical axis OA5. In operation, the light from the object side is imaged on an image plane IMA5.

According to the foregoing, wherein: both of the object side surface S51 and image side surface S52 of the first lens L51 are spherical surfaces; the second lens L52 is a meniscus lens, wherein the object side surface S53 is a convex surface and the image side surface S54 is a concave surface; the third lens L53 is a meniscus lens, wherein the object side surface S55 is a concave surface and both of the object side surface S55 and image side surface S56 are aspheric surfaces; both of the object side surface S58 and image side surface S59 of the fourth lens L54 are spherical surfaces; the fifth lens L55 is a meniscus lens, wherein the object side surface S510 is convex surface; both of the object side surface S511 and image side surface S512 of the sixth lens L56 are spherical surfaces; the fifth lens L55 is cemented with the sixth lens L56; the seventh lens L57 is a meniscus lens with negative refractive power and made of glass material, wherein the object side surface S513 is a concave surface, the image side surface S514 is a convex surface, and both of the object side surface S513 and image side surface S514 are aspheric surfaces; both of object side surface S515 and image side surface S516 of the optical filter OF5 are plane surfaces; and both of the object side surface S517 and image side surface S518 of the cover glass CG5 are plane surfaces.

With the above design of the lenses, stop ST5, and at least one of the conditions (2)-(4), (6)-(9), (12)-(22) satisfied, the lens assembly 5 can have an effective decreased F-number, an effective increased resolution, an effective corrected aberration, and an effective corrected chromatic aberration.

Table 13 shows the optical specification of the lens assembly 5 in FIG. 16.

TABLE 13
Effective Focal Length = 5.73 mm
F-number = 1.80
Total Lens Length = 44.62 mm
Field of View = 98.80 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S51 | 18.89 | 0.95 | 1.77 | 49.6 | −11.234 | L51 |
| S52 | 5.84 | 3.41 | | | | |
| S53 | 52.18 | 1.96 | 1.51 | 60.5 | −27.248 | L52 |
| S54 | 10.90 | 6.15 | | | | |
| S55 | −38.24 | 6.41 | 1.58 | 59.4 | 21.182 | L53 |
| S56 | −9.93 | −0.04 | | | | |
| S57 | ∞ | 2.22 | | | | ST5 |
| S58 | 36.31 | 2.98 | 1.5 | 81.6 | 19.37 | L54 |
| S59 | −12.81 | 5.77 | | | | |
| S510 | 31.77 | 1.28 | 1.85 | 23.8 | −11.577 | L55 |
| S511 | 7.43 | 4.64 | 1.55 | 75.5 | 10.061 | L56 |
| S512 | −17.18 | 4.74 | | | | |
| S513 | −129.07 | 0.56 | 1.52 | 64.1 | −284.04 | L57 |
| S514 | −1067.87 | 0.73 | | | | |
| S515 | ∞ | 0.21 | 1.52 | 64.2 | | OF5 |
| S516 | ∞ | 1.65 | | | | |
| S517 | ∞ | 0.50 | 1.52 | 64.2 | | CG5 |
| S518 | ∞ | 0.50 | | | | |

In the fifth embodiment, the conic constant k and the aspheric coefficients A, B, C, D, E, F, G of each aspheric lens are shown in Table 14.

TABLE 14

| Surface | | | | | | | | |
|---|---|---|---|---|---|---|---|---|
| Number | k | A | B | C | D | E | F | G |
| S55 | −99.1661 | −0.0004 | 5.3918E−06 | 9.16E−08 | 0 | 0 | 0 | 0 |
| S56 | −1.0069 | −1.9E−05 | −2.2095E−07 | 4.49E−08 | 0 | 0 | 0 | 0 |
| S513 | 406.2991 | −0.0018 | 4.9878E−05 | 0 | 0 | 0 | 0 | 0 |
| S514 | −107.102 | −0.0017 | 5.0874E−05 | 0 | 0 | 0 | 0 | 0 |

Table 15 shows the parameters and condition values for conditions (2)-(4), (6)-(9), (12)-(22) in accordance with the fifth embodiment of the invention. It can be seen from Table 15 that the lens assembly 5 of the fifth embodiment satisfies the conditions (2)-(4), (6)-(9), (12)-(22).

TABLE 15

| | | | | | |
|---|---|---|---|---|---|
| CT4 | 2.98 | L4T2 | 1.00 mm | Td23 | 6.15 |
| | mm | | | | mm |
| fF | −634.39 | Tz | 0.56 mm | BFL | 3.59 |
| | mm | | | | mm |
| dSI | 25.78 | CT2 | 1.96 mm | CT3 | 6.41 |
| | mm | | | | mm |
| CT6 | 4.64 | | | | |
| | mm | | | | |
| CT4/L4T2 | 2.99 | f4/f | 3.38 | Vd2/Vd3 | 1.02 |
| Vd4/Vd5 | 3.43 | Vd5/Vd6 | 0.32 | \|R22 − R31\| | 49.14 |
| | | | | | mm |
| f3/f | 3.70 | FOV/f1 | −8.79 | (R21 × R22)/f2 | −20.87 |
| | | | degree/mm | | mm |
| (f1 + f2)/f | −6.72 | fF/f | −110.71 | Tz/BFL | 0.16 |
| (R41 − R32)/CT6 | 9.97 | dSI/Td23 | 4.19 | CT2/Td23 | 0.32 |
| CT3/Td23 | 1.04 | CT4/Td23 | 0.48 | CT6/Td23 | 0.75 |

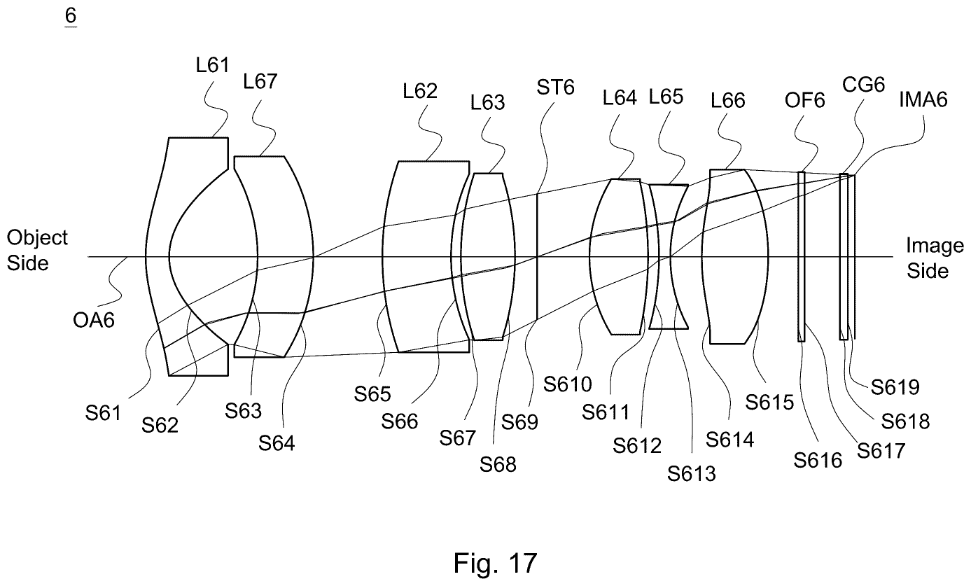

A detailed description of a lens assembly in accordance with a sixth embodiment of the invention is as follows. Referring to FIG. 17, the lens assembly 6 includes a first lens L61, a seventh lens L67, a second lens L62, a third lens L63, a stop ST6, a fourth lens L64, a fifth lens L65, a sixth lens L66, an optical filter OF6, and a cover glass CG6, all of which are arranged in order from an object side to an image side along an optical axis OA6. In operation, the light from the object side is imaged on an image plane IMA6.

According to the foregoing, wherein: both of the object side surface S61 and image side surface S62 of the first lens L61 are aspheric surfaces; the second lens L62 is a meniscus lens, wherein the object side surface S65 is a convex surface and the image side surface S66 is a concave surface; the third lens L63 is a biconvex lens, wherein the object side surface S67 is a convex surface and both of the object side surface S67 and image side surface S68 are spherical surfaces; both of the object side surface S610 and image side surface S611 of the fourth lens L64 are spherical surfaces; the fifth lens L65 is a biconcave lens, wherein the object side surface S612 is concave surface; both of the object side surface S614 and image side surface S615 of the sixth lens L66 are aspheric surfaces; the seventh lens L67 is a meniscus lens with positive refractive power and made of glass material, wherein the object side surface S63 is a concave surface, the image side surface S64 is a convex surface, and both of the object side surface S63 and image side surface S64 are spherical surfaces; both of object side surface S616 and image side surface S617 of the optical filter OF6 are plane surfaces; and both of the object side surface S618 and image side surface S619 of the cover glass CG6 are plane surfaces.

With the above design of the lenses, stop ST6, and at least one of the conditions (2)-(4), (6)-(9), (12)-(22) satisfied, the lens assembly 6 can have an effective decreased F-number, an effective increased resolution, an effective corrected aberration, and an effective corrected chromatic aberration.

Table 16 shows the optical specification of the lens assembly 6 in FIG. 17.

TABLE 16
Effective Focal Length = 5.73 mm
F-number = 1.80
Total Lens Length = 44.59 mm
Field of View = 98.80 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S61 | 8.75 | 1.48 | 1.77 | 49.5 | −8.383 | L61 |
| S62 | 3.83 | 5.54 | | | | |
| S63 | −11.45 | 3.54 | 1.81 | 41 | 122.729 | L67 |
| S64 | −11.70 | 4.35 | | | | |
| S65 | 18.58 | 4.31 | 1.81 | 22.7 | −70.164 | L62 |
| S66 | 12.58 | 0.59 | | | | |
| S67 | 16.56 | 3.43 | 1.73 | 54.7 | 11.879 | L63 |
| S68 | −16.79 | 1.38 | | | | |
| S69 | ∞ | 3.30 | | | | ST6 |
| S610 | 9.42 | 3.68 | 1.57 | 71.3 | 12.084 | L64 |
| S611 | −22.23 | 0.69 | | | | |
| S612 | −17.07 | 0.72 | 1.74 | 27.8 | −8.052 | L65 |
| S613 | 9.51 | 1.96 | | | | |
| S614 | 13.68 | 4.18 | 1.59 | 67 | 11.777 | L66 |
| S615 | −12.63 | 1.89 | | | | |
| S616 | ∞ | 0.21 | 1.52 | 64.2 | | OF6 |
| S617 | ∞ | 1.65 | | | | |
| S618 | ∞ | 0.50 | 1.52 | 64.2 | | CG6 |
| S619 | ∞ | 0.50 | | | | |

In the sixth embodiment, the conic constant k and the aspheric coefficients A, B, C, D, E, F, G of each aspheric lens are shown in Table 17.

TABLE 17

| Surface | | | | | | | | |
|---|---|---|---|---|---|---|---|---|
| Number | k | A | B | C | D | E | F | G |
| S61 | −6.08 | −2.19E−04 | 6.59E−07 | 1.56E−09 | 0 | 0 | 0 | 0 |
| S62 | −1.83 | 1.00E−03 | −8.43E−06 | 1.53E−09 | 0 | 0 | 0 | 0 |
| S614 | −0.01 | −4.82E−04 | −1.07E−06 | −2.76E−07 | 0 | 0 | 0 | 0 |
| S615 | −0.32 | −2.96E−05 | −4.34E−06 | −1.34E−07 | 0 | 0 | 0 | 0 |

Table 18 shows the parameters and condition values for conditions (2)-(4), (6)-(9), (12)-(22) in accordance with the sixth embodiment of the invention. It can be seen from Table 18 that the lens assembly 6 of the sixth embodiment satisfies the conditions (2)-(4), (6)-(9), (12)-(22).

TABLE 18

| | | | | | |
|---|---|---|---|---|---|
| CT4 | 3.68 | L4T2 | 1.80 | Td23 | 0.59 |
| | mm | | mm | | mm |
| fF | 12.37 | Tz | 4.18 | BFL | 5.44 |
| | mm | | mm | | mm |
| dSI | 19.97 | CT2 | 4.31 | CT3 | 3.43 |
| | mm | | mm | | mm |
| CT6 | 4.18 | | | | |
| | mm | | | | |
| CT4/L4T2 | 2.04 | f4/f | 2.11 | Vd2/Vd3 | 0.41 |
| Vd4/Vd5 | 2.56 | Vd5/Vd6 | 0.41 | \|R22 − R31\| | 3.98 |
| | | | | | mm |
| f3/f | 2.06 | FOV/f1 | −11.79 | (R21 × R22)/f2 | −3.33 |
| | | | degree/mm | | mm |
| (f1 + f2)/f | −13.71 | fF/f | 2.16 | Tz/BFL | 0.77 |
| (R41 − R32)/CT6 | 6.27 | dSI/Td23 | 33.85 | CT2/Td23 | 7.31 |
| CT3/Td23 | 5.81 | CT4/Td23 | 6.24 | CT6/Td23 | 7.08 |

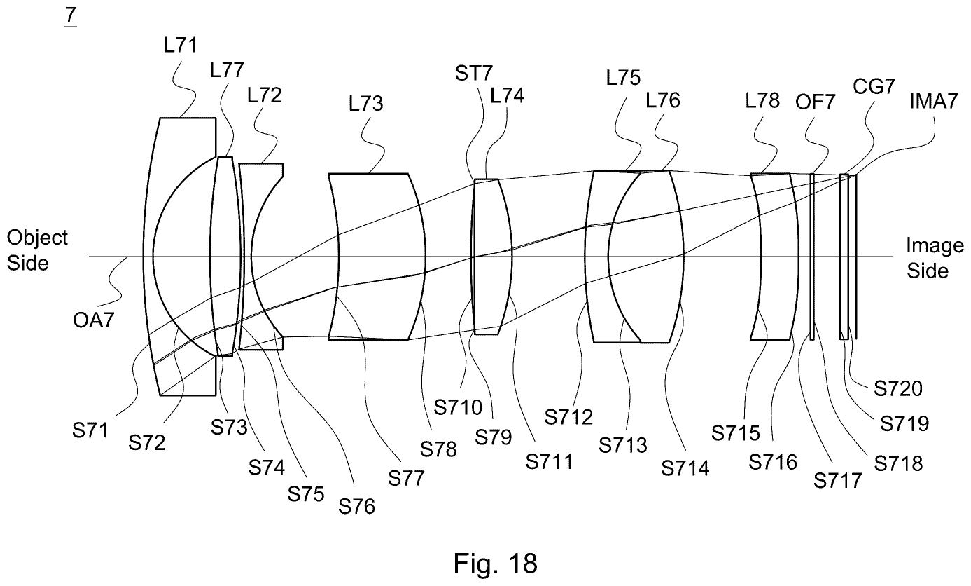

A detailed description of a lens assembly in accordance with a seventh embodiment of the invention is as follows. Referring to FIG. 18, the lens assembly 7 includes a first lens L71, a seventh lens L77, a second lens L72, a third lens L73, a stop ST7, a fourth lens L74, a fifth lens L75, a sixth lens L76, an eighth lens L78, an optical filter OF7, and a cover glass CG7, all of which are arranged in order from an object side to an image side along an optical axis OA7. In operation, the light from the object side is imaged on an image plane IMA7.

According to the foregoing, wherein: both of the object side surface S71 and image side surface S72 of the first lens L71 are spherical surfaces; the second lens L72 is a biconcave lens, wherein the object side surface S75 is a concave surface and the image side surface S76 is a concave surface; the third lens L73 is a meniscus lens, wherein the object side surface S77 is a concave surface and both of the object side surface S77 and image side surface S78 are aspheric surfaces; both of the object side surface S710 and image side surface S711 of the fourth lens L74 are spherical surfaces; the fifth lens L75 is a meniscus lens, wherein the object side surface S712 is a convex surface; both of the object side surface S713 and image side surface S714 of the sixth lens L76 are spherical surfaces; the fifth lens L75 is cemented with the sixth lens L76; the seventh lens L77 is a biconvex lens with positive refractive power and made of glass material, wherein the object side surface S73 is a convex surface, the image side surface S74 is a convex surface, and both of the object side surface S73 and image side surface S74 are spherical surfaces; the eighth lens L78 is a meniscus lens with negative refractive power and made of glass material, wherein the object side surface S715 is a concave surface, the image side surface S716 is a convex surface, and both of the object side surface S715 and image side surface S716 are aspheric surfaces; both of object side surface S717 and image side surface S718 of the optical filter OF7 are plane surfaces; and both of the object side surface S719 and image side surface S720 of the cover glass CG7 are plane surfaces.

With the above design of the lenses, stop ST7, and at least one of the conditions (2)-(9), (12)-(22) satisfied, the lens assembly 7 can have an effective decreased F-number, an effective increased resolution, an effective corrected aberration, and an effective corrected chromatic aberration.

Table 19 shows the optical specification of the lens assembly 7 in FIG. 18.

TABLE 19
Effective Focal Length = 5.73 mm
F-number = 1.80
Total Lens Length = 44.57 mm
Field of View = 98.81 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S71 | 36.16 | 0.59 | 1.62 | 63.9 | −13.893 | L71 |
| S72 | 6.94 | 3.59 | | | | |
| S73 | 38.01 | 1.93 | 1.8 | 45.5 | 22.681 | L77 |
| S74 | −34.71 | 0.20 | | | | |
| S75 | −53.68 | 0.48 | 1.52 | 63.3 | −12.561 | L72 |
| S76 | 7.50 | 5.44 | | | | |
| S77 | −18.84 | 5.46 | 1.58 | 59.4 | 37.753 | L73 |
| S78 | −11.25 | 3.02 | | | | |
| S79 | ∞ | −0.22 | | | | ST7 |
| S710 | 44.60 | 2.56 | 1.62 | 63.8 | 17.241 | L74 |
| S711 | −13.87 | 4.58 | | | | |
| S712 | 26.46 | 1.44 | 1.85 | 23.8 | −13.346 | L75 |
| S713 | 7.80 | 4.71 | 1.59 | 68.6 | 9.599 | L76 |
| S714 | −16.62 | 4.84 | | | | |
| S715 | −46.81 | 2.35 | 1.52 | 64.1 | −1897.9 | L78 |
| S716 | −50.00 | 0.74 | | | | |
| S717 | ∞ | 0.21 | 1.52 | 64.2 | | OF7 |
| S718 | ∞ | 1.65 | | | | |
| S719 | ∞ | 0.50 | 1.52 | 64.2 | | CG7 |
| S720 | ∞ | 0.50 | | | | |

In the seventh embodiment, the conic constant k and the aspheric coefficients A, B, C, D, E, F, G of each aspheric lens are shown in Table 20.

TABLE 20

| Surface | | | | | | | | |
|---|---|---|---|---|---|---|---|---|
| Number | k | A | B | C | D | E | F | G |
| S77 | 1.56 | −1.04E−04 | 2.90E−06 | 2.36E−07 | 0 | 0 | 0 | 0 |
| S78 | −1.03 | 2.42E−05 | 8.36E−07 | 6.55E−08 | 0 | 0 | 0 | 0 |
| S715 | −128.46 | −1.05E−03 | 1.59E−05 | 0.00E+00 | 0 | 0 | 0 | 0 |
| S716 | 74.33 | −8.03E−04 | 2.03E−05 | 0.00E+00 | 0 | 0 | 0 | 0 |

Table 21 shows the parameters and condition values for conditions (2)-(9), (12)-(22) in accordance with the seventh embodiment of the invention. It can be seen from Table 21 that the lens assembly 7 of the seventh embodiment satisfies the conditions (2)-(9), (12)-(22).

TABLE 21

| | | | | | |
|---|---|---|---|---|---|
| CT4 | 2.56 | L4T2 | 1.45 | Td23 | 5.44 |
| | mm | | mm | | mm |
| fF | −21.81 | Tz | 2.35 | BFL | 3.60 |
| | mm | | mm | | mm |
| dSI | 23.86 | CT2 | 0.48 | CT3 | 5.46 |
| | mm | | mm | | mm |
| CT6 | 4.71 | | | | |
| | mm | | | | |
| CT4/L4T2 | 1.77 | f4/f | 3.01 | Vd2/Vd3 | 1.07 |
| Vd4/Vd5 | 2.68 | Vd5/Vd6 | 0.35 | \|R22 − R31\| | 26.34 |
| | | | | | mm |
| f3/f | 6.59 | FOV/f1 | −7.11 | (R21 × R22)/f2 | 32.05 |
| | | | degree/mm | | mm |
| (f1 + f2)/f | −4.62 | fF/f | −3.81 | Tz/BFL | 0.65 |
| (R41 − R32)/CT6 | 11.86 | dSI/Td23 | 4.39 | CT2/Td23 | 0.09 |
| CT3/Td23 | 1.00 | CT4/Td23 | 0.47 | CT6/Td23 | 0.87 |
| Vd4 | 63.8 | | | | |

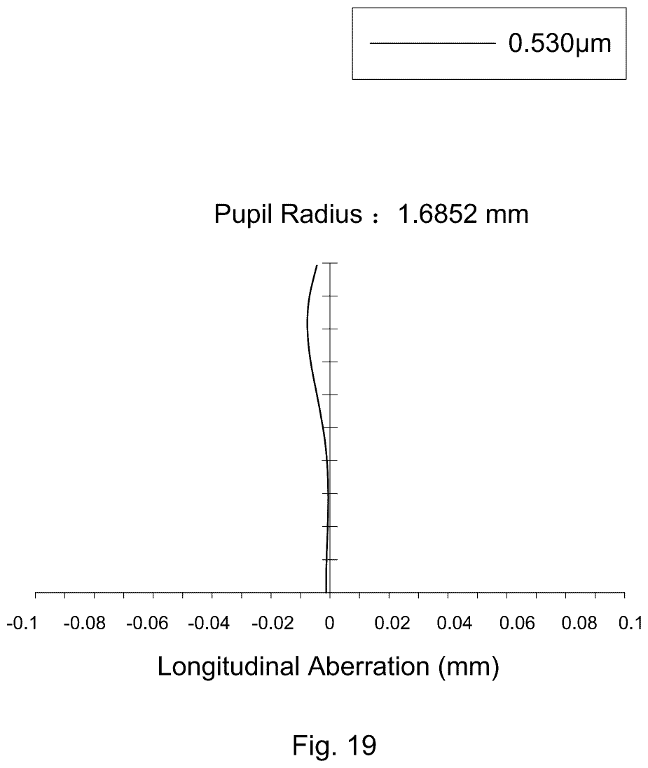

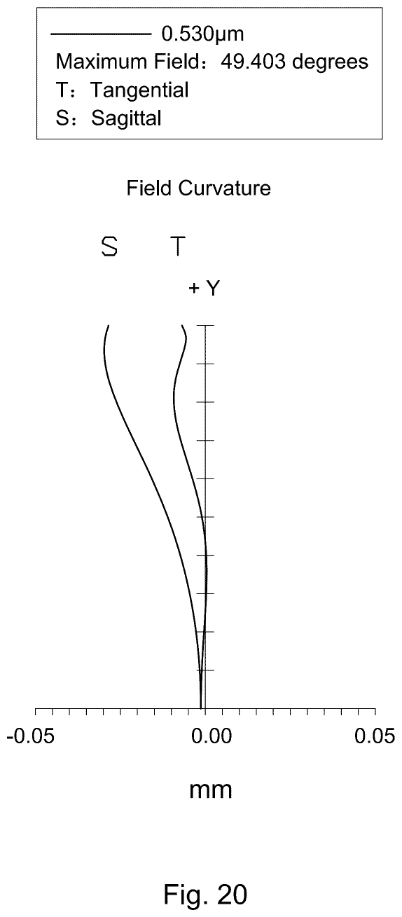

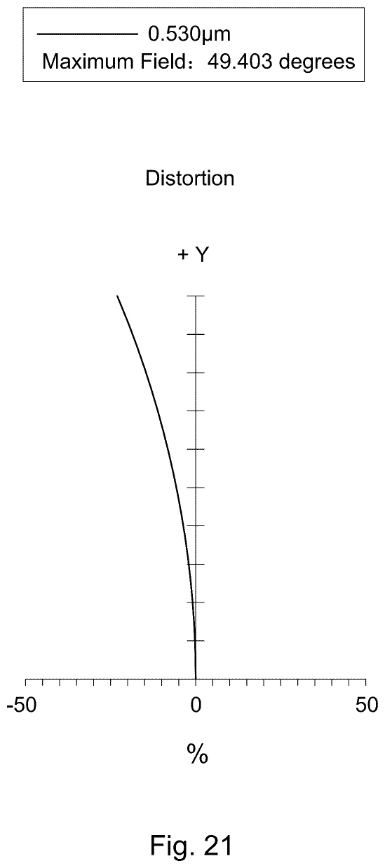

In addition, the lens assembly 7 of the seventh embodiment can meet the requirements of optical performance as seen in FIGS. 19-21. It can be seen from FIG. 19 that the longitudinal aberration in the lens assembly 7 of the seventh embodiment ranges from −0.01 mm to 0.0 mm. It can be seen from FIG. 20 that the field curvature of tangential direction and sagittal direction in the lens assembly 7 of the seventh embodiment ranges from −0.03 mm to 0.005 mm. It can be seen from FIG. 21 that the distortion in the lens assembly 7 of the seventh embodiment ranges from −25% to 0%. It is obvious that the longitudinal aberration, the field curvature, and the distortion of the lens assembly 7 of the seventh embodiment can be corrected effectively. Therefore, the lens assembly 7 of the seventh embodiment is capable of good optical performance.

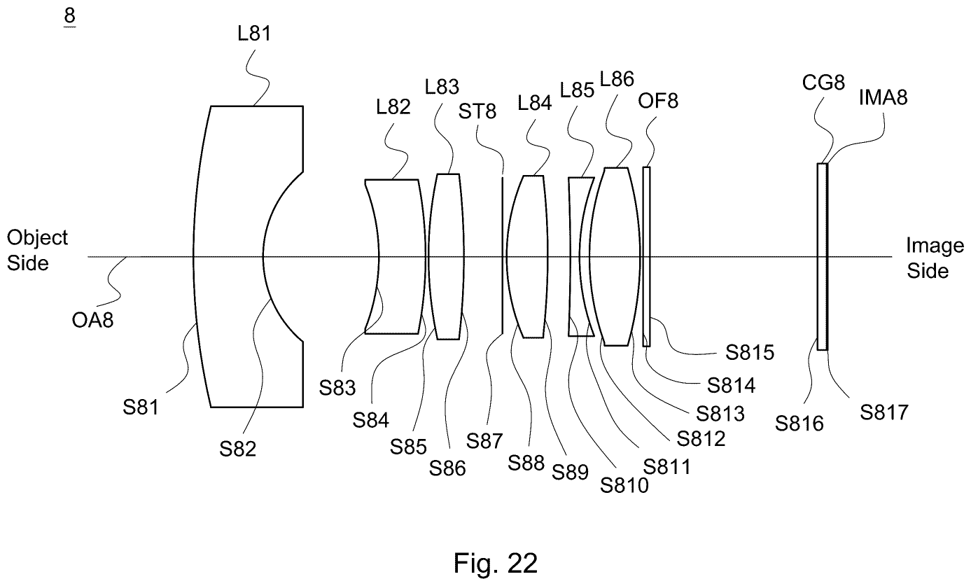

A detailed description of a lens assembly in accordance with an eighth embodiment of the invention is as follows. Referring to FIG. 22, the lens assembly 8 includes a first lens L81, a second lens L82, a third lens L83, a stop ST8, a fourth lens L84, a fifth lens L85, a sixth lens L86, an optical filter OF8, and a cover glass CG8, all of which are arranged in order from an object side to an image side along an optical axis OA8. In operation, the light from the object side is imaged on an image plane IMA8.

According to the foregoing, wherein: both of the object side surface S81 and image side surface S82 of the first lens L81 are spherical surfaces; the second lens L82 is a meniscus lens, wherein the object side surface S83 is a concave surface and the image side surface S84 is a convex surface; the third lens L83 is a biconvex lens, wherein the object side surface S85 is a convex surface and both of the object side surface S85 and image side surface S86 are spherical surfaces; both of the object side surface S88 and image side surface S89 of the fourth lens L84 are aspheric surfaces; the fifth lens L85 is a biconcave lens, wherein the object side surface S810 is concave surface; both of the object side surface S812 and image side surface S813 of the sixth lens L86 are aspheric surfaces; both of object side surface S814 and image side surface S815 of the optical filter OF8 are plane surfaces; and both of the object side surface S816 and image side surface S817 of the cover glass CG8 are plane surfaces. With the above design of the lenses, stop ST8, and at least one of the conditions (1)-(22) satisfied, the lens assembly 8 can have an effective decreased F-number, an effective increased resolution, an effective corrected aberration, and an effective corrected chromatic aberration.

Table 22 shows the optical specification of the lens assembly 8 in FIG. 22.

TABLE 22
Effective Focal Length = 4.22 mm
F-number = 1.68
Total Lens Length = 27.34 mm
Field of View = 102.85 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S81 | 23.59 | 2.96 | 1.87071 | 40.7286 | −6.0855 | L81 |
| S82 | 4.09 | 5.05 | | | | |
| S83 | −7.23 | 2.01 | 1.7433 | 49.2216 | −21.4 | L82 |
| S84 | −14.77 | 0.15 | | | | |
| S85 | 15.00 | 1.51 | 1.80809 | 22.7643 | 11.6718 | L83 |
| S86 | −24.94 | 1.66 | | | | |
| S87 | ∞ | 0.18 | | | | ST8 |
| S88 | 7.36 | 1.78 | 1.59419 | 67.2954 | 9.33611 | L84 |
| S89 | −20.79 | 0.97 | | | | |
| S810 | −62.42 | 0.39 | 1.98613 | 16.4839 | −7.1781 | L85 |
| S811 | 8.14 | 0.43 | | | | |
| S812 | 8.72 | 2.17 | 1.7331 | 48.9 | 6.84372 | L86 |
| S813 | −10.69 | 0.13 | | | | |
| S814 | ∞ | 0.30 | 1.5168 | 64.1673 | | OF8 |
| S815 | ∞ | 7.22 | | | | |
| S816 | ∞ | 0.40 | 1.5168 | 64.1673 | | CG8 |
| S817 | ∞ | 0.04 | | | | |

In the eighth embodiment, the conic constant k and the aspheric coefficients A, B, C, D, E, F, G of each aspheric lens are shown in Table 23.

TABLE 23

| Surface | | A | B | C | |
|---|---|---|---|---|---|
| Number | k | E | F | G | D |
| S88 | 0 | −2.32E−04 | 1.61E−05 | −2.18E−06 | 2.02E−07 |
| | | −5.54E−09 | −6.27E−10 | 3.25E−11 | |
| S89 | 0 | 2.94E−04 | 2.01E−05 | −1.73E−06 | 1.30E−07 |
| | | 2.99E−09 | −1.64E−09 | 7.58E−11 | |
| S812 | 0 | −6.77E−04 | 2.38E−05 | −1.58E−06 | 1.31E−07 |
| | | 9.67E−09 | −1.67E−09 | 6.21E−11 | |
| S813 | 0 | 2.10E−04 | 2.53E−05 | −3.50E−06 | 2.68E−07 |
| | | 9.81E−09 | −1.86E−09 | 6.51E−11 | |

Table 24 shows the parameters and condition values for conditions (2)-(9), (12)-(22) in accordance with the eighth embodiment of the invention. It can be seen from Table 24 that the lens assembly 8 of the eighth embodiment satisfies the conditions (2)-(9), (12)-(22).

TABLE 24

| | | | | | |
|---|---|---|---|---|---|
| CT4 | 1.78 | L4T2 | 0.86 | Td23 | 0.15 |
| | mm | | mm | | mm |
| fF | −23.79 | Tz | 2.17 | BFL | 8.09 |
| | mm | | mm | | mm |
| dSI | 14.01 | CT2 | 2.01 | CT3 | 1.51 |
| | mm | | mm | | mm |
| CT6 | 2.17 | | | | |
| | mm | | | | |
| CT4/L4T2 | 2.07 | f4/f | 2.21 | Vd2/Vd3 | 2.16 |
| Vd4/Vd5 | 4.08 | Vd5/Vd6 | 0.34 | \|R22 − R31\| | 29.78 |
| | | | | | mm |
| f3/f | 2.76 | FOV/f1 | −16.9 | (R21 × R22)/f2 | −4.99 |
| | | | degree/mm | | mm |
| (f1 + f2)/f | −6.51 | fF/f | −5.63 | Tz/BFL | 0.27 |
| (R41 − R32)/CT6 | 14.88 | dSI/Td23 | 93.40 | CT2/Td23 | 13.08 |
| CT3/Td23 | 9.82 | CT4/Td23 | 11.56 | CT6/Td23 | 14.14 |
| Vd4 | 67.3 | | | | |

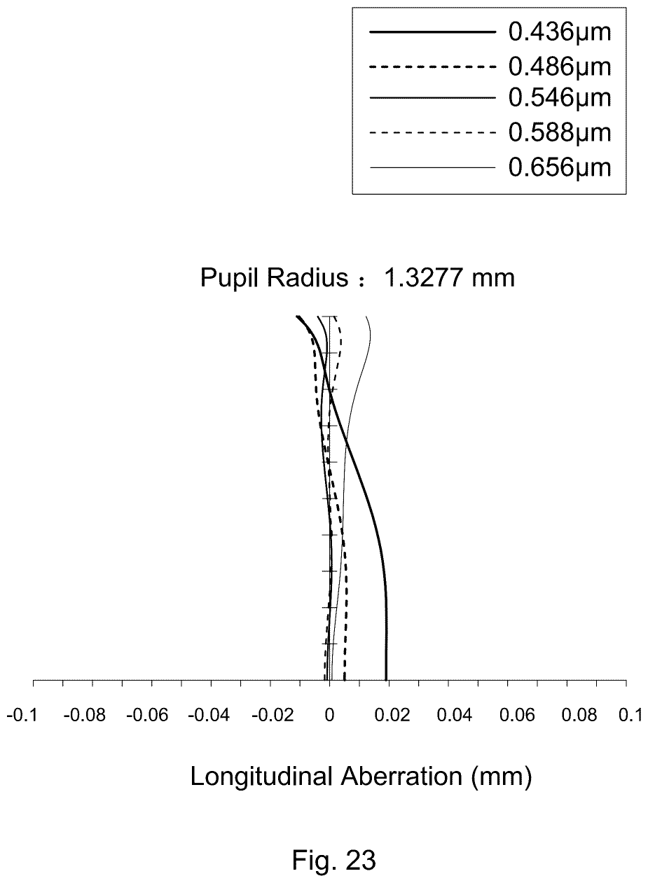

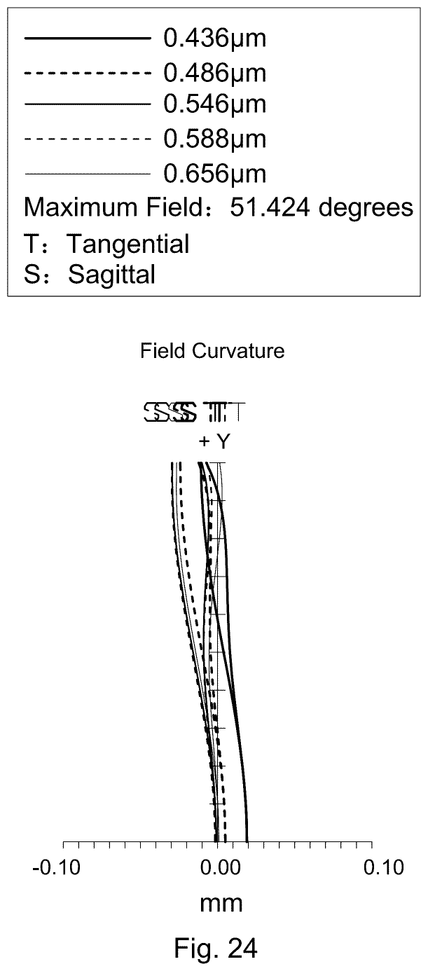

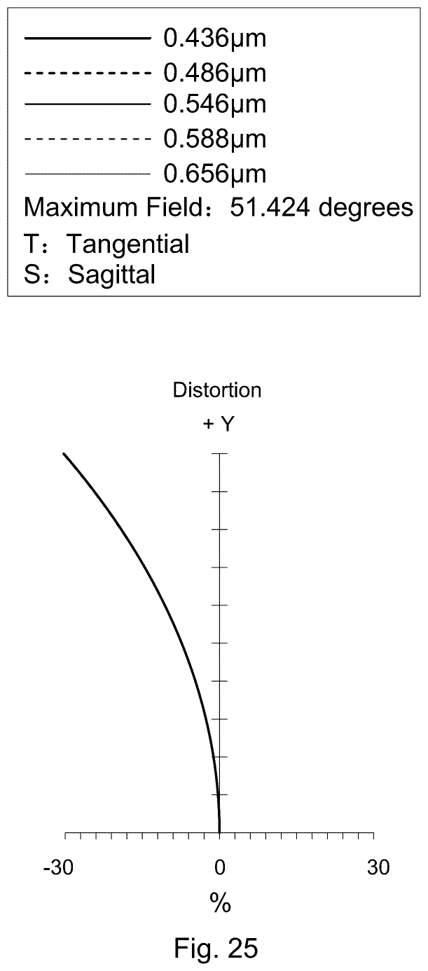

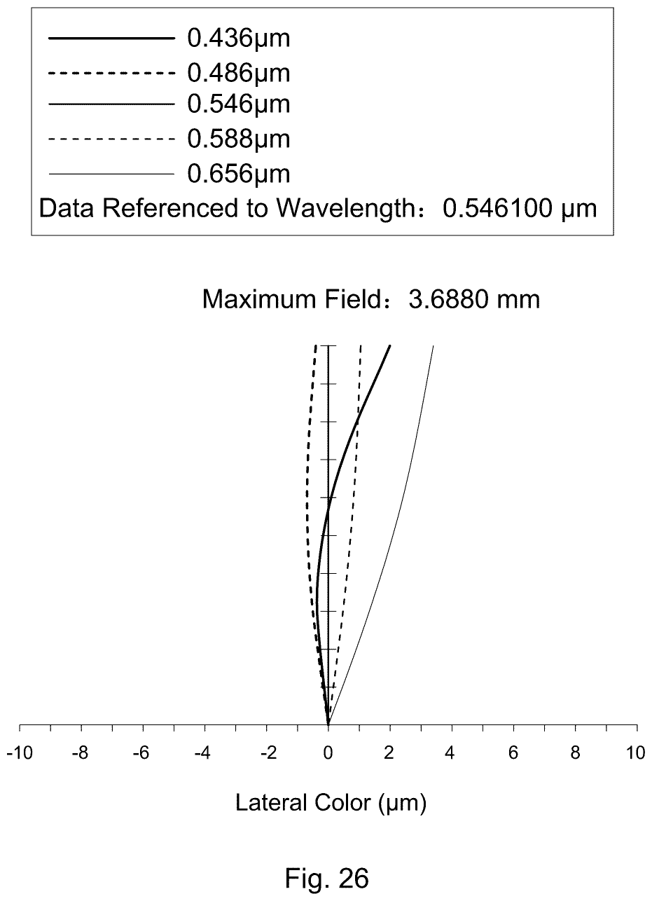

In addition, the lens assembly 8 of the eighth embodiment can meet the requirements of optical performance as seen in FIGS. 23-26. It can be seen from FIG. 23 that the longitudinal aberration in the lens assembly 8 of the eighth embodiment ranges from −0.015 mm to 0.02 mm. It can be seen from FIG. 24 that the field curvature of tangential direction and sagittal direction in the lens assembly 8 of the eighth embodiment ranges from −0.04 mm to 0.02 mm. It can be seen from FIG. 25 that the distortion in the lens assembly 8 of the eighth embodiment ranges from −30% to 0%. It can be seen from FIG. 26 that the lateral color in the lens assembly 8 of the eighth embodiment ranges from −1 μm to 4 μm. It is obvious that the longitudinal aberration, the field curvature, the distortion, and the lateral color of the lens assembly 8 of the eighth embodiment can be corrected effectively. Therefore, the lens assembly 8 of the eighth embodiment is capable of good optical performance.

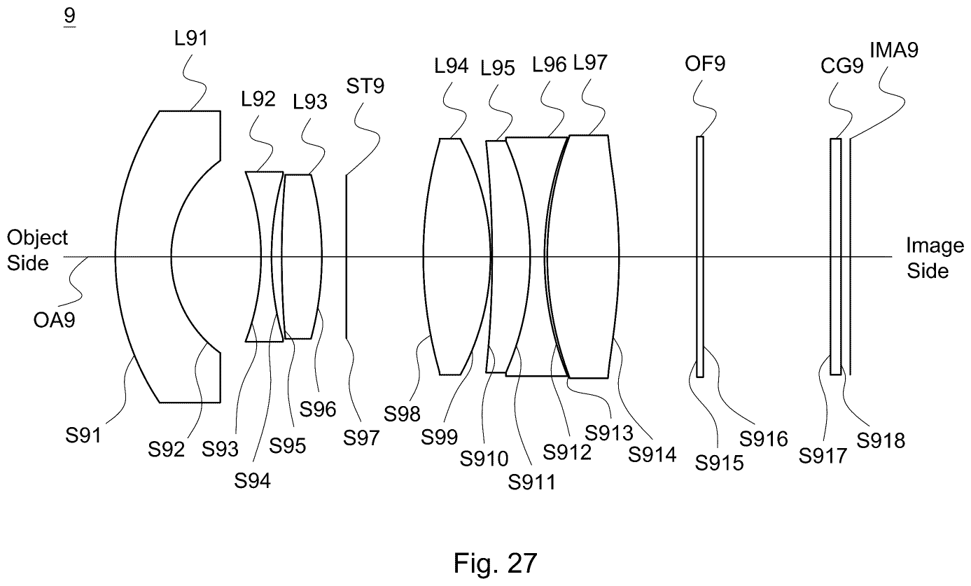

A detailed description of a lens assembly in accordance with a ninth embodiment of the invention is as follows. Referring to FIG. 27, the lens assembly 9 includes a first lens L91, a second lens L92, a third lens L93, a stop ST9, a fourth lens L94, a fifth lens L95, a sixth lens L96, a seventh lens L97, an optical filter OF9, and a cover glass CG9, all of which are arranged in order from an object side to an image side along an optical axis OA9. In operation, the light from the object side is imaged on an image plane IMA9.

The first lens L91 is a meniscus lens with negative refractive power and made of glass material, wherein the object side surface S91 is a convex surface, the image side surface S92 is a concave surface, and both of the object side surface S91 and image side surface S92 are spherical surfaces.

The second lens L92 is a biconcave lens with negative refractive power and made of glass material, wherein the object side surface S93 is a concave surface, the image side surface S94 is a concave surface, and both of the object side surface S93 and image side surface S94 are spherical surfaces.

The third lens L93 is a biconvex lens with positive refractive power and made of glass material, wherein the object side surface S95 is a convex surface, the image side surface S96 is a convex surface, and both of the object side surface S95 and image side surface S96 are spherical surfaces.

The fourth lens L94 is a biconvex lens with positive refractive power and made of glass material, wherein the object side surface S98 is a convex surface, the image side surface S99 is a convex surface, and both of the object side surface S98 and image side surface S99 are aspheric surfaces.

The fifth lens L95 is a meniscus lens with positive refractive power and made of glass material, wherein the object side surface S910 is a concave surface, the image side surface S911 is a convex surface, and both of the object side surface S910 and image side surface S911 are spherical surfaces.

The sixth lens L96 is a biconcave lens with negative refractive power and made of glass material, wherein the object side surface S911 is a concave surface, the image side surface S912 is a concave surface, and both of the object side surface S911 and image side surface S912 are spherical surfaces.

The fifth lens L95 is cemented with the sixth lens L96.

The seventh lens L97 is a biconvex lens with positive refractive power and made of glass material, wherein the object side surface S913 is a convex surface, the image side surface S914 is a convex surface, and both of the object side surface S913 and image side surface S914 are aspheric surfaces.

Both of the object side surface S915 and image side surface S916 of the optical filter OF9 are plane surfaces.

Both of the object side surface S917 and image side surface S918 of the cover glass CG9 are plane surfaces.

In addition, the lens assembly 9 satisfies at least one of the above conditions (1), (3)-(5), (8)-(16), (18)-(22). With the above design of the lenses, stop ST9, and at least one of the conditions (1), (3)-(5), (8)-(16), (18)-(22) satisfied, the lens assembly 9 can have an effective decreased F-number, an effective increased resolution, an effective corrected aberration, and an effective corrected chromatic aberration.

Table 25 shows the optical specification of the lens assembly 9 in FIG. 27.

TABLE 25
Effective Focal Length = 7.93 mm
F-number = 1.71
Total Lens Length = 35.01 mm
Field of View = 74.63 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S91 | 10.77 | 2.66 | 1.62041 | 60.3438 | −17.945 | L91 |
| S92 | 4.97 | 4.27 | | | | |
| S93 | −9.65 | 0.50 | 1.56883 | 56.0441 | −9.2671 | L92 |
| S94 | 12.00 | 0.50 | | | | |
| S95 | 40.80 | 1.89 | 1.90043 | 37.3724 | 10.9804 | L93 |
| S96 | −12.92 | 1.18 | | | | |
| S97 | ∞ | 3.68 | | | | ST9 |
| S98 | 15.98 | 3.19 | 1.59197 | 67.193 | 10.4991 | L94 |
| S99 | −9.49 | 0.08 | | | | |
| S910 | −43.91 | 1.80 | 1.59282 | 68.6244 | 26.4386 | L95 |
| S911 | −11.77 | 0.69 | 1.6843 | 26.8134 | −8.8051 | L96 |
| S912 | 12.98 | 0.14 | | | | |
| S913 | 14.33 | 3.41 | 1.7331 | 48.9 | 11.8345 | L97 |
| S914 | −20.12 | 3.71 | | | | |
| S915 | ∞ | 0.30 | 1.517 | 64.167 | | OF9 |
| S916 | ∞ | 6.08 | | | | |
| S917 | ∞ | 0.50 | 1.517 | 64.167 | | CG9 |
| S918 | ∞ | 0.44 | | | | |

In the ninth embodiment, the conic constant k and the aspheric coefficients A. B. C. D. E. F. G of each aspheric lens are shown in Table 26.

TABLE 26

| Surface | | A | B | C | |
|---|---|---|---|---|---|
| Number | k | E | F | G | D |
| S98 | 0 | −7.89E−05 | −1.37E−06 | 4.74E−08 | 3.88E−09 |
| | | −4.04E−10 | 1.32E−11 | −1.38E−13 | |
| S99 | 0 | 1.08E−04 | 1.27E−06 | −8.82E−08 | 5.52E−09 |
| | | −4.21E−11 | −4.54E−12 | 1.08E−13 | |
| S913 | 0 | −7.59E−06 | 1.12E−06 | 1.85E−08 | 8.28E−10 |
| | | 1.19E−11 | −3.69E−13 | 3.93E−15 | |
| S914 | 0 | 1.55E−04 | 2.18E−07 | 6.97E−08 | 4.73E−10 |
| | | −5.81E−12 | 1.33E−13 | 9.75E−15 | |

Table 27 shows the parameters and condition values for conditions (1), (3)-(5), (8)-(16), (18)-(22) in accordance with the ninth embodiment of the invention. It can be seen from Table 27 that the lens assembly 9 of the ninth embodiment satisfies the conditions (1), (3)-(5), (8)-(16), (18)-(22).

TABLE 27

| | | | | | |
|---|---|---|---|---|---|
| CT6 | 0.69 | CT2 | 0.50 | CT3 | 1.89 |
| | mm | | mm | | mm |
| Td12 | 4.27 | Td23 | 0.50 | Td34 | 4.85 |
| | mm | | mm | | mm |
| Td45 | 0.08 | fF | −19.40 | Tz | 3.41 |
| | mm | | mm | | mm |
| BFL | 11.02 | dSI | 24.01 | CT4 | 3.19 |
| | mm | | mm | | mm |
| f × tan(FOV/2) × TTL | 211.59 | f4/f | 1.32 | Vd2/Vd3 | 1.50 |
| | mm2 | | | | |
| Vd4 | 67.19 | \|R22 − R31\| | 28.80 | f3/f | 1.38 |
| | | | mm | | |
| Td12/Td34 | 0.88 | Td34/Td45 | 57.15 | FOV/f1 | −4.16 |
| | | | | | degree/mm |
| (R21 × R22)/f2 | 23.92 | (f1 + f2)/f | −3.43 | fF/f | −2.45 |
| Tz/BFL | 0.31 | dSI/Td23 | 48.31 | CT2/Td23 | 1.00 |
| CT3/Td23 | 3.81 | CT4/Td23 | 6.41 | CT6/Td23 | 1.39 |

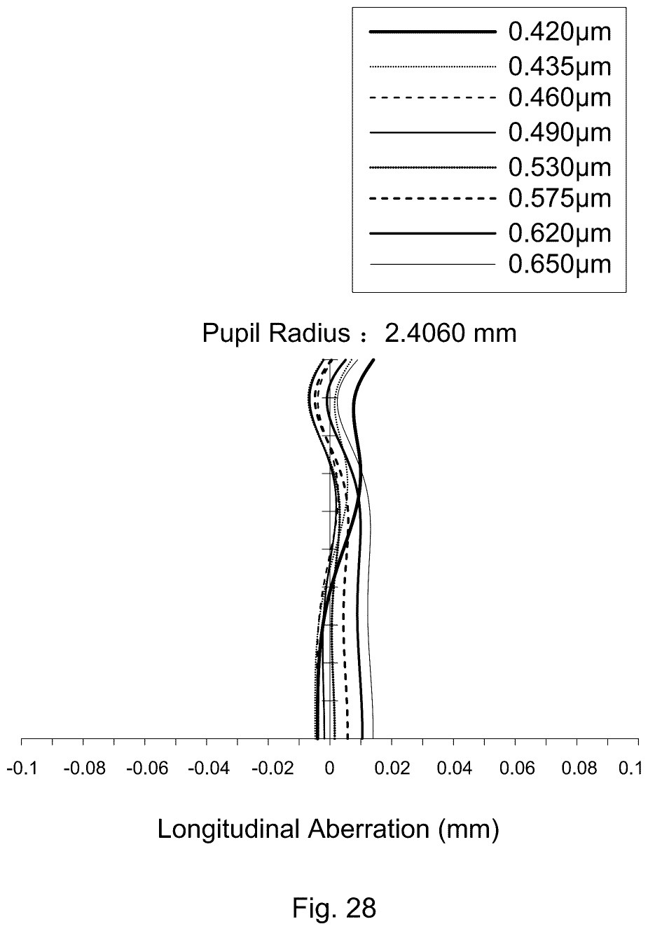

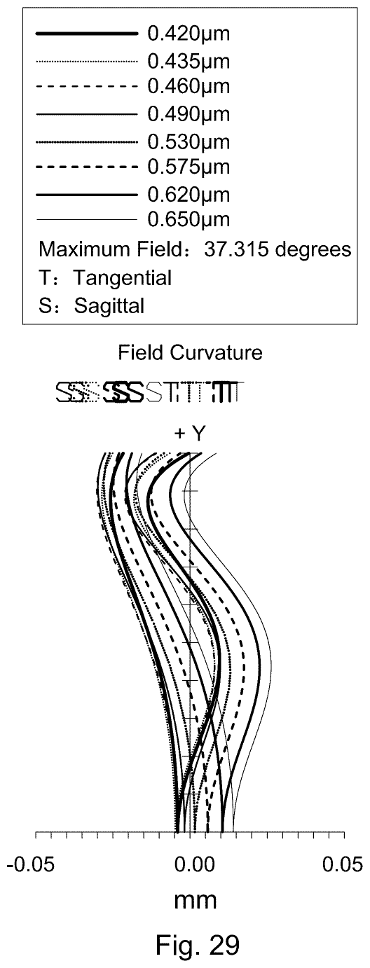

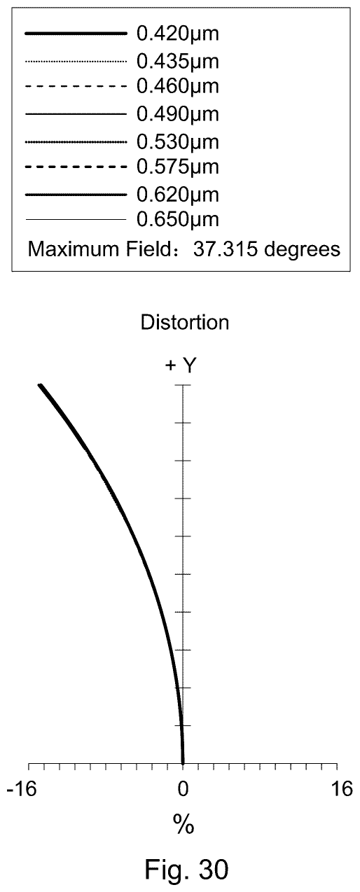

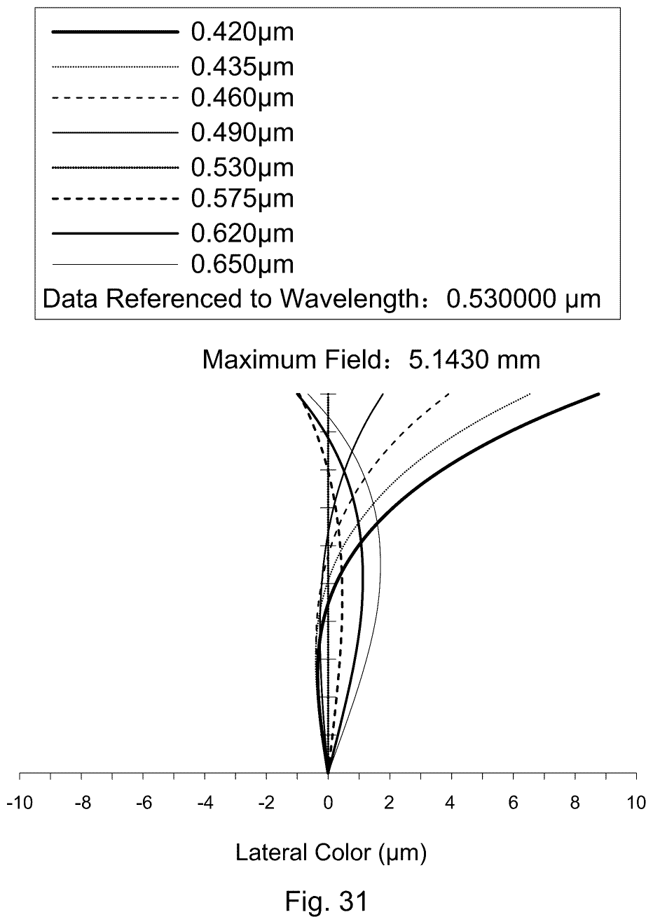

In addition, the lens assembly 9 of the ninth embodiment can meet the requirements of optical performance as seen in FIGS. 28-31. It can be seen from FIG. 28 that the longitudinal aberration in the lens assembly 9 of the ninth embodiment ranges from −0.01 mm to 0.02 mm. It can be seen from FIG. 29 that the field curvature of tangential direction and sagittal direction in the lens assembly 9 of the ninth embodiment ranges from −0.03 mm to 0.03 mm. It can be seen from FIG. 30 that the distortion in the lens assembly 9 of the ninth embodiment ranges from −16% to 0%. It can be seen from FIG. 31 that the lateral color in the lens assembly 9 of the ninth embodiment ranges from −1 μm to 9 μm. It is obvious that the longitudinal aberration, the field curvature, the distortion, and the lateral color of the lens assembly 9 of the ninth embodiment can be corrected effectively. Therefore, the lens assembly 9 of the ninth embodiment is capable of good optical performance.

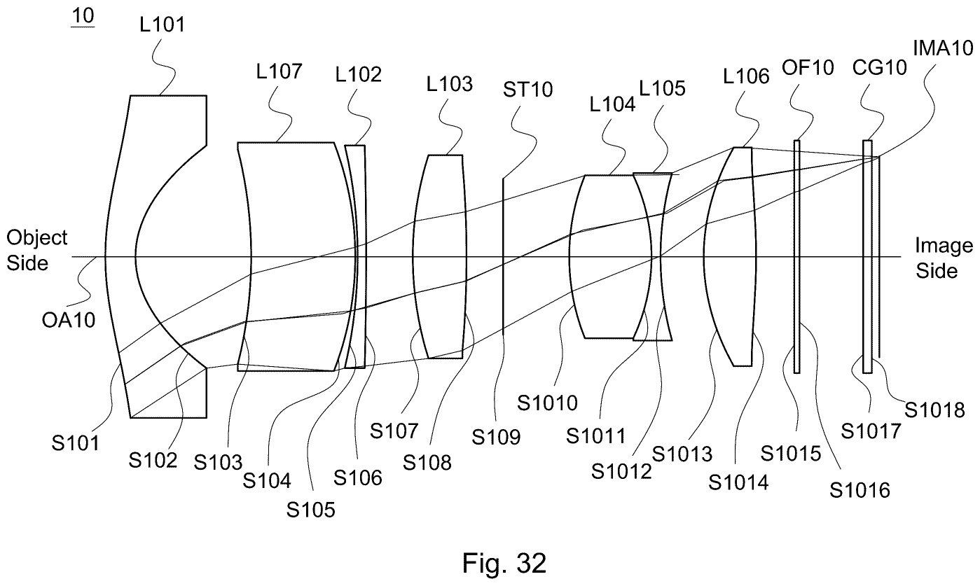

A detailed description of a lens assembly in accordance with a tenth embodiment of the invention is as follows. Referring to FIG. 32, the lens assembly 10 includes a first lens L101, a seventh lens L107, a second lens L102, a third lens L103, a stop ST10, a fourth lens L104, a fifth lens L105, a sixth lens L106, an optical filter OF10, and a cover glass CG10, all of which are arranged in order from an object side to an image side along an optical axis OA10. In operation, the light from the object side is imaged on an image plane IMA10.

The first lens L101 is a meniscus lens with negative refractive power and made of glass material, wherein the object side surface S101 is a convex surface, the image side surface S102 is a concave surface, and both of the object side surface S101 and image side surface S102 are aspheric surfaces.

The second lens L102 is a meniscus lens with negative refractive power and made of glass material, wherein the object side surface S105 is a concave surface, the image side surface S106 is a convex surface, and both of the object side surface S105 and image side surface S106 are spherical surfaces.

The third lens L103 is a biconvex lens with positive refractive power and made of glass material, wherein the object side surface S107 is a convex surface, the image side surface S108 is a convex surface, and both of the object side surface S107 and image side surface S108 are spherical surfaces.

The fourth lens L104 is a biconvex lens with positive refractive power and made of glass material, wherein the object side surface S1010 is a convex surface, the image side surface S1011 is a convex surface, and both of the object side surface S1010 and image side surface S1011 are spherical surfaces.

The fifth lens L105 is a biconcave lens with negative refractive power and made of glass material, wherein the object side surface S1011 is a concave surface, the image side surface S1012 is a concave surface, and both of the object side surface S1011 and image side surface S1012 are spherical surfaces.

The fourth lens L104 is cemented with the fifth lens L105.

The sixth lens L106 is a biconvex lens with positive refractive power and made of glass material, wherein the object side surface S1013 is a convex surface, the image side surface S1014 is a convex surface, and both of the object side surface S1013 and image side surface S1014 are spherical surfaces.

The seventh lens L107 is a meniscus lens with positive refractive power and made of glass material, wherein the object side surface S103 is a concave surface, the image side surface S104 is a convex surface, and both of the object side surface S103 and image side surface S104 are aspheric surfaces.

Both of the object side surface S915 and image side surface S916 of the optical filter OF9 are plane surfaces.

Both of the object side surface S917 and image side surface S918 of the cover glass CG9 are plane surfaces.

In addition, the lens assembly 10 satisfies at least one of the above conditions (2)-(4), (6)-(7), (9), (12), (14), (16), (18)-(22). With the above design of the lenses, stop ST10, and at least one of the conditions (2)-(4), (6)-(7), (9), (12), (14), (16), (18)-(22) satisfied, the lens assembly 10 can have an effective decreased F-number, an effective increased resolution, an effective corrected aberration, and an effective corrected chromatic aberration.

Table 28 shows the optical specification of the lens assembly 10 in FIG. 32.

TABLE 28
Effective Focal Length = 5.50 mm
F-number = 1.76
Total Lens Length = 44.60 mm
Field of View = 98.80 degrees

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S101 | 12.47 | 1.74 | 1.77 | 49.5 | −8.81 | L101 |
| S102 | 4.15 | 6.67 | | | | |
| S103 | −20.00 | 5.98 | 1.81 | 41 | 46.89 | L107 |
| S104 | −14.87 | 0.15 | | | | |
| S105 | −22.59 | 0.50 | 1.52 | 64.2 | −49.75 | L102 |
| S106 | −180.63 | 2.68 | | | | |
| S107 | 15.78 | 3.08 | 1.73 | 54.7 | 16.74 | L103 |
| S108 | −50.83 | 2.12 | | | | |
| S109 | ∞ | 3.84 | | | | |
| S1010 | 10.54 | 4.73 | 1.57 | 71.3 | 9.18 | L104 |
| S1011 | −8.75 | 0.50 | 1.74 | 27.8 | −7.19 | L105 |
| S1012 | 14.41 | 2.48 | | | | |
| S1013 | 9.20 | 3.02 | 1.59 | 67 | 11.99 | L106 |
| S1014 | −28.12 | 2.20 | | | | |
| S1015 | ∞ | 0.30 | 1.52 | 64.2 | | OF10 |
| S1016 | ∞ | 3.67 | | | | |
| S1017 | ∞ | 0.50 | 1.52 | 64.2 | | CG10 |
| S1018 | ∞ | 0.44 | | | | |

In the tenth embodiment, the conic constant k and the aspheric coefficients A. B. C. D. E. F. G of each aspheric lens are shown in Table 29.

TABLE 29

| Surface | | | | |
|---|---|---|---|---|
| Number | k | A | B | C |
| S101 | −9.49E−01 | −4.29E−04 | 2.74E−06 | −8.39E−09 |
| S102 | −1.01E+00 | 2.02E−04 | −4.37E−06 | 6.84E−08 |
| S103 | −1.40E+00 | 2.24E−05 | 1.10E−06 | 2.18E−09 |
| S104 | −3.92E+01 | 1.65E−04 | 8.26E−07 | −1.21E−08 |

Table 30 shows the parameters and condition values for conditions (2)-(4). (6)-(7). (9). (12). (14). (16). (18)-(22) in accordance with the tenth embodiment of the invention. It can be seen from Table 30 that the lens assembly 10 of the tenth embodiment satisfies the conditions (2)-(4), (6)-(7), (9), (12), (14), (16), (18)-(22).

TABLE 30

| | | | | | | | |
|---|---|---|---|---|---|---|---|
| CT4 | 4.73 | mm | L4T2 | 2.79 mm | Tz | 3.02 | mm |
| BFL | 7.10 | mm | CT6 | 3.02 mm | dSI | 21.68 | mm |
| Td23 | 2.68 | mm | CT2 | 0.50 mm | CT3 | 3.08 | mm |

| CT4/L4T2 | 1.69 | | f4/f | 1.67 | Vd2/Vd3 | 1.17 |
|---|---|---|---|---|---|---|
| Vd4/Vd5 | 2.56 | | Vd5/Vd6 | 0.41 | f3/f | 3.04 |
| FOV/f1 | −11.22 | degree/mm | (f1 + f2)/f | −10.65 | Tz/BFL | 0.43 |

| | | | | | |
|---|---|---|---|---|---|
| dSI/Td23 | 8.07 | CT2/Td23 | 0.19 | CT3/Td23 | 1.15 |
| CT4/Td23 | 1.76 | CT6/Td23 | 1.12 | | |

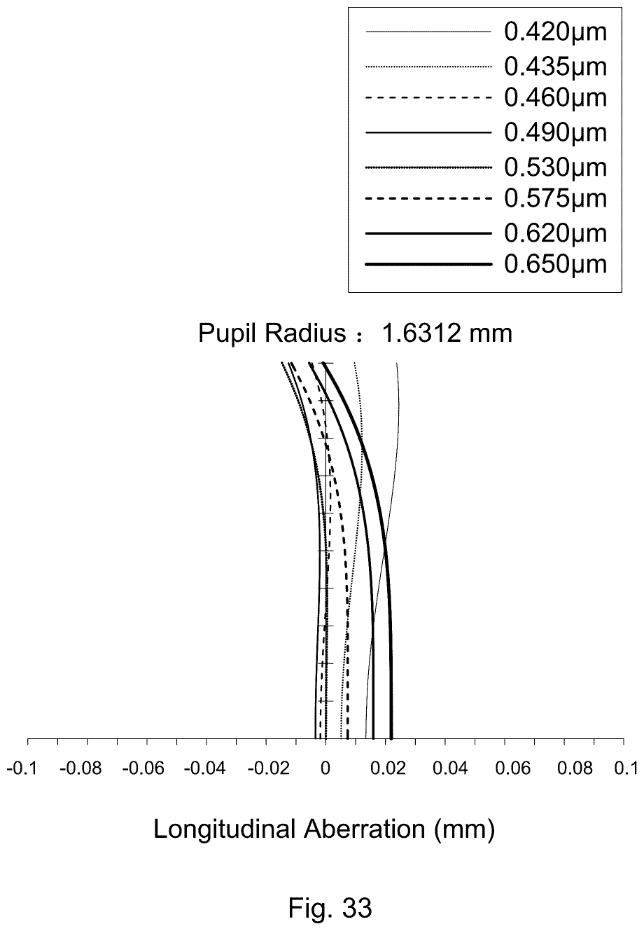

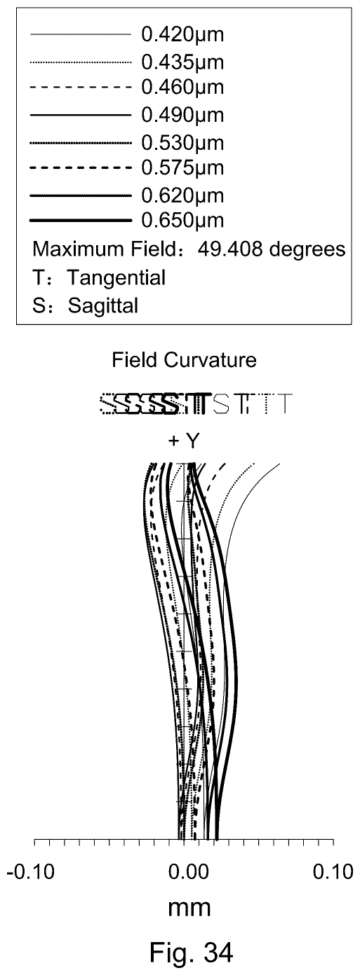

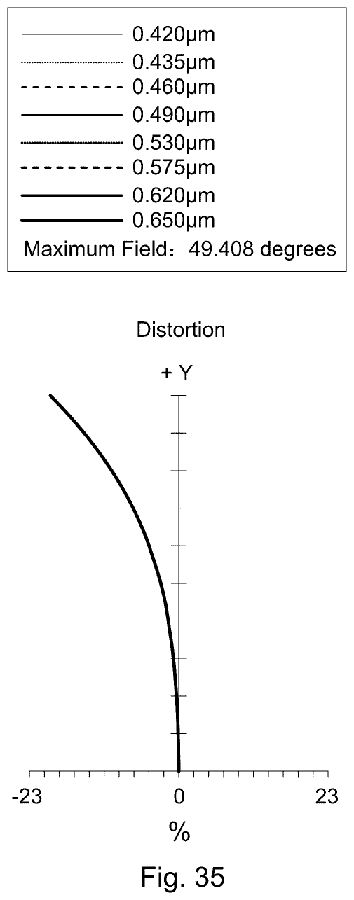

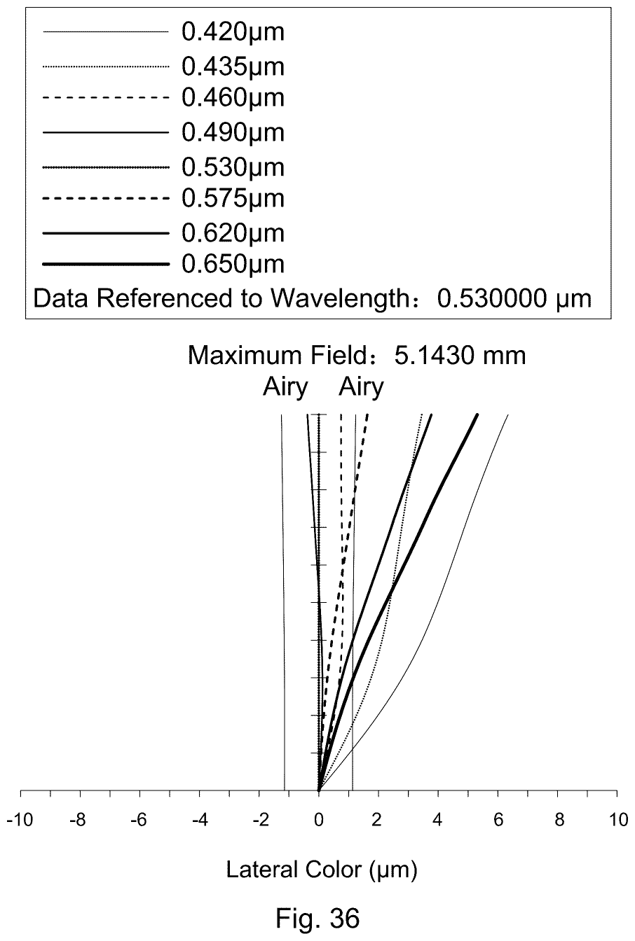

In addition, the lens assembly 10 of the tenth embodiment can meet the requirements of optical performance as seen in FIGS. 33-36. It can be seen from FIG. 33 that the longitudinal aberration in the lens assembly 10 of the tenth embodiment ranges from −0.02 mm to 0.03 mm. It can be seen from FIG. 34 that the field curvature of tangential direction and sagittal direction in the lens assembly 10 of the tenth embodiment ranges from −0.03 mm to 0.07 mm. It can be seen from FIG. 35 that the distortion in the lens assembly 10 of the tenth embodiment ranges from −23% to 0%. It can be seen from FIG. 36 that the lateral color in the lens assembly 10 of the tenth embodiment ranges from −1 μm to 7 μm. It is obvious that the longitudinal aberration, the field curvature, the distortion, and the lateral color of the lens assembly 10 of the tenth embodiment can be corrected effectively. Therefore, the lens assembly 10 of the tenth embodiment is capable of good optical performance.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lens assembly comprising:
a first lens which is with negative refractive power;
a second lens which is with refractive power;
a third lens which is with positive refractive power and comprises a convex surface facing an image side;
a fourth lens which is with positive refractive power and comprises a convex surface facing an object side;
a fifth lens which is with refractive power; and
a sixth lens which is with refractive power;
wherein the first lens, the second lens, the third lens, the fourth lens, the fifth lens, and the sixth lens are arranged in order from the object side to the image side along an optical axis;
wherein the lens assembly satisfies following condition:
−17 degree/mm≤FOV/f1≤−4 degree/mm;
wherein FOV is a field of view of the lens assembly and f1 is an effective focal length of the first lens;
wherein the lens assembly satisfies at least one of following conditions:
$$200 {mm}^{2} \leq f \times tan ( FOV / 2 ) \times TTL \leq 20 {mm}^{2} ;$$
$$0.8 \leq Td 12 / Td 34 \leq 1.1 ;$$
$$25.2 \leq Td 34 / Td 45 \leq 61.8 ;$$
wherein FOV is the field of view of the lens assembly, f is an effective focal length of the lens assembly, TTL is an interval from an object side surface of the first lens to an image plane along the optical axis, Td12 is an air interval from an image side surface of the first lens to an object side surface of the second lens along the optical axis, Td34 is an air interval from an image side surface of the third lens to an object side surface of the fourth lens along the optical axis, and Td45 is an air interval from an image side surface of the fourth lens to an object side surface of the fifth lens along the optical axis.

2. The lens assembly as claimed in claim 1, wherein:
the first lens is a meniscus lens and comprises a convex surface facing the object side and a concave surface facing the image side;
the second lens is with negative refractive power; and
the fourth lens comprises a convex surface facing the image side.

3. The lens assembly as claimed in claim 2, wherein:
the second lens is a meniscus lens and comprises a concave surface facing the object side and a convex surface facing the image side;
the third lens further comprises a concave surface facing the object side;
the fifth lens is a biconcave lens with negative refractive power and comprises a concave surface facing the object side and another concave surface facing the image side;
the sixth lens is a biconvex lens with positive refractive power and comprises a convex surface facing the object side and another convex surface facing the image side; and
the fifth lens and the sixth lens are cemented.

4. The lens assembly as claimed in claim 3, further comprising a stop disposed between the third lens and the fourth lens, wherein the lens assembly satisfies at least one of following conditions:
$$1.4 \leq CT 4 / L 4 T 2 \leq 3.2 ;$$
$$0.95 \leq f 4 / f \leq 3.45 ;$$
$$0.4 \leq Vd 2 / Vd 3 \leq 2.2 ;$$
$$2 \leq Vd 4 / Vd 5 \leq 4.1 ;$$
$$0.3 \leq Vd 5 / Vd 6 \leq 0.42 ;$$
$$3 mm \leq \vert R 22 - R 31 \vert \leq 80 mm ;$$
$$1.2 \leq f 3 / f \leq 6.8 ;$$
$$- 21.5 mm \leq ( R 21 \times R 22 ) / f 2 \leq 32.5 mm ;$$
$$- 15 \leq ( f 1 + f 2 ) / f \leq - 3 ;$$
$$- 111 \leq fF / f \leq 2.2 ;$$
$$0.1 \leq Tz / BFL \leq 1.4 ;$$
$$62 \leq Vd 4 \leq 68 ;$$
$$4 \leq dSI / Td 23 \leq 94 ;$$
$$5.9 \leq ( R 41 - R 32 ) / CT 6 \leq 15.1 ;$$
$$0.05 \leq CT 2 / Td 23 \leq 13.35 ;$$
$$0.9 \leq CT 3 / Td 23 \leq 9.9 ;$$
$$0.4 \leq CT 4 / Td 23 \leq 11.8 ;$$
$$0.7 \leq CT 6 / Td 23 \leq 14.3 ;$$
wherein CT2 is an interval from the object side surface of the second lens to an image side surface of the second lens along the optical axis, CT3 is an interval from an object side surface of the third lens to the image side surface of the third lens along the optical axis, CT4 is an interval from the object side surface of the fourth lens to the image side surface of the fourth lens along the optical axis, CT6 is an interval from an object side surface of the sixth lens to an image side surface of the sixth lens along the optical axis, LAT2 is an interval from the outermost edge of the object side surface of the fourth lens to the outermost edge of the image side surface of the fourth lens along the optical axis, f1 is the effective focal length of the first lens, f2 is an effective focal length of the second lens, f3 is an effective focal length of the third lens, f4 is an effective focal length of the fourth lens, f is the effective focal length of the lens assembly, fF is an effective focal length of a combination of the lenses between the object side and the stop, Tz is an interval from an object side surface of the lens closest to the image side to an image side surface of the lens closest to the image side along the optical axis, BFL is an interval from the image side surface of the lens closest to the image side to the image plane along the optical axis, dSI is an interval from the stop to the image plane along the optical axis, Vd2 is an Abbe number of the second lens, Vd3 is an Abbe number of the third lens, Vd4 is an Abbe number of the fourth lens, Vd5 is an Abbe number of the fifth lens, Vd6 is an Abbe number of the sixth lens, R21 is a radius of curvature of the object side surface of the second lens, R22 is a radius of curvature of the image side surface of the second lens, R31 is a radius of curvature of the object side surface of the third lens, R32 is a radius of curvature of the image side surface of the third lens, R41 is a radius of curvature of the object side surface of the fourth lens, and Td23 is an air interval from the image side surface of the second lens to the object side surface of the third lens along the optical axis.

5. The lens assembly as claimed in claim 2, further comprising a seventh lens disposed between the sixth lens and the image side, wherein:
the second lens is a biconcave lens and comprises a concave surface facing the object side and another concave surface facing the image side;
the third lens is a biconvex lens and further comprises another convex surface facing the object side;
the fifth lens is a biconcave lens with negative refractive power and comprises a concave surface facing the object side and another concave surface facing the image side;
the sixth lens is a biconvex lens with positive refractive power and comprises a convex surface facing the object side and another convex surface facing the image side;
the seventh lens is a biconvex lens with positive refractive power and comprises a convex surface facing the object side and another convex surface facing the image side; and
the fifth lens and the sixth lens are cemented.

6. The lens assembly as claimed in claim 5, further comprising a stop disposed between the third lens and the fourth lens, wherein the lens assembly satisfies at least one of following conditions:
$$1.4 \leq CT 4 / L 4 T 2 \leq 3.2 ;$$
$$0.95 \leq f 4 / f \leq 3.45 ;$$
$$0.4 \leq Vd 2 / Vd 3 \leq 2.2 ;$$
$$2 \leq Vd 4 / Vd 5 \leq 4.1 ;$$
$$0.3 \leq Vd 5 / Vd 6 \leq 0.42 ;$$
$$3 mm \leq \vert R 22 - R 31 \vert \leq 80 mm ;$$
$$1.2 \leq f 3 / f \leq 6.8 ;$$
$$- 21.5 mm \leq ( R 21 \times R 22 ) / f 2 \leq 32.5 mm ;$$
$$- 15 \leq ( f 1 + f 2 ) / f \leq - 3 ;$$
$$- 111 \leq fF / f \leq 2.2 ;$$
$$0.1 \leq Tz / BFL \leq 1.4 ;$$
$$62 \leq Vd 4 \leq 68 ;$$
$$4 \leq dSI / Td 23 \leq 94 ;$$
$$5.9 \leq ( R 41 - R 32 ) / CT 6 \leq 15.1 ;$$
$$0.5 \leq CT 2 / Td 23 \leq 13.35 ;$$
$$0.9 \leq CT 3 / Td 23 \leq 9.9 ;$$
$$0.4 \leq CT 4 / Td 23 \leq 11.8 ;$$
$$0.7 \leq CT 6 / Td 23 \leq 14.3 ;$$
wherein CT2 is an interval from the object side surface of the second lens to an image side surface of the second lens along the optical axis, CT3 is an interval from an object side surface of the third lens to the image side surface of the third lens along the optical axis, CT4 is an interval from the object side surface of the fourth lens to the image side surface of the fourth lens along the optical axis, CT6 is an interval from an object side surface of the sixth lens to an image side surface of the sixth lens along the optical axis, LAT2 is an interval from the outermost edge of the object side surface of the fourth lens to the outermost edge of the image side surface of the fourth lens along the optical axis, f1 is the effective focal length of the first lens, f2 is an effective focal length of the second lens, f3 is an effective focal length of the third lens, f4 is an effective focal length of the fourth lens, f is the effective focal length of the lens assembly, fF is an effective focal length of a combination of the lenses between the object side and the stop, Tz is an interval from an object side surface of the lens closest to the image side to an image side surface of the lens closest to the image side along the optical axis, BFL is an interval from the image side surface of the lens closest to the image side to the image plane along the optical axis, dSI is an interval from the stop to the image plane along the optical axis, Vd2 is an Abbe number of the second lens, Vd3 is an Abbe number of the third lens, Vd4 is an Abbe number of the fourth lens, Vd5 is an Abbe number of the fifth lens, Vd6 is an Abbe number of the sixth lens, R21 is a radius of curvature of the object side surface of the second lens, R22 is a radius of curvature of the image side surface of the second lens, R31 is a radius of curvature of the object side surface of the third lens, R32 is a radius of curvature of the image side surface of the third lens, R41 is a radius of curvature of the object side surface of the fourth lens, and Td23 is an air interval from the image side surface of the second lens to the object side surface of the third lens along the optical axis.

7. The lens assembly as claimed in claim 2, further comprising a seventh lens disposed between the sixth lens and the image side, wherein:
the second lens is a biconcave lens and comprises a concave surface facing the object side and another concave surface facing the image side;
the third lens is a biconvex lens and further comprises another convex surface facing the object side;
the fifth lens is a biconcave lens with negative refractive power and comprises a concave surface facing the object side and another concave surface facing the image side;
the sixth lens is a biconvex lens with positive refractive power and comprises a convex surface facing the object side and another convex surface facing the image side; and
the seventh lens is a meniscus lens with positive refractive power and comprises a convex surface facing the object side and a concave surface facing the image side.

8. The lens assembly as claimed in claim 2, wherein:
the second lens is a meniscus lens and comprises a concave surface facing the object side and a convex surface facing the image side;
the third lens is a biconvex lens and further comprises another convex surface facing the object side;
the fifth lens is a biconcave lens with negative refractive power and comprises a concave surface facing the object side and another concave surface facing the image side; and
the sixth lens is a biconvex lens with positive refractive power and comprises a convex surface facing the object side and another convex surface facing the image side.

9. The lens assembly as claimed in claim 8, further comprising a stop disposed between the third lens and the fourth lens, wherein the lens assembly satisfies at least one of following conditions:
$$1.4 \leq CT 4 / L 4 T 2 \leq 3.2 ;$$
$$0.95 \leq f 4 / f \leq 3.45 ;$$
$$0.4 \leq Vd 2 / Vd 3 \leq 2.2 ;$$
$$2 \leq Vd 4 / Vd 5 \leq 4.1 ;$$
$$0.3 \leq Vd 5 / Vd 6 \leq 0.42 ;$$
$$3 mm \leq \vert R 22 - R 31 \vert \leq 80 mm ;$$
$$1.2 \leq f 3 / f \leq 6.8 ;$$
$$- 21.5 mm \leq ( R 21 \times R 22 ) / f 2 \leq 32.5 mm ;$$
$$- 15 \leq ( f 1 + f 2 ) / f \leq - 3 ;$$
$$- 111 \leq fF / f \leq 2.2 ;$$
$$0.1 \leq Tz / BFL \leq 1.4 ;$$
$$62 \leq Vd 4 \leq 68 ;$$
$$4 \leq dSI / Td 23 \leq 94 ;$$
$$5.9 \leq ( R 41 - R 32 ) / CT 6 \leq 15.1 ;$$
$$0.05 \leq CT 2 / Td 23 \leq 13.35 ;$$
$$0.9 \leq CT 3 / Td 23 \leq 9.9 ;$$
$$0.4 \leq CT 4 / Td 23 \leq 11.8 ;$$
$$0.7 \leq CT 6 / Td 23 \leq 14.3 ;$$
wherein CT2 is an interval from the object side surface of the second lens to an image side surface of the second lens along the optical axis, CT3 is an interval from an object side surface of the third lens to the image side surface of the third lens along the optical axis, CT4 is an interval from the object side surface of the fourth lens to the image side surface of the fourth lens along the optical axis, CT6 is an interval from an object side surface of the sixth lens to an image side surface of the sixth lens along the optical axis, LAT2 is an interval from the outermost edge of the object side surface of the fourth lens to the outermost edge of the image side surface of the fourth lens along the optical axis, f1 is the effective focal length of the first lens, f2 is an effective focal length of the second lens, f3 is an effective focal length of the third lens, f4 is an effective focal length of the fourth lens, f is the effective focal length of the lens assembly, fF is an effective focal length of a combination of the lenses between the object side and the stop, Tz is an interval from an object side surface of the lens closest to the image side to an image side surface of the lens closest to the image side along the optical axis, BFL is an interval from the image side surface of the lens closest to the image side to the image plane along the optical axis, dSI is an interval from the stop to the image plane along the optical axis, Vd2 is an Abbe number of the second lens, Vd3 is an Abbe number of the third lens, Vd4 is an Abbe number of the fourth lens, Vd5 is an Abbe number of the fifth lens, Vd6 is an Abbe number of the sixth lens, R21 is a radius of curvature of the object side surface of the second lens, R22 is a radius of curvature of the image side surface of the second lens, R31 is a radius of curvature of the object side surface of the third lens, R32 is a radius of curvature of the image side surface of the third lens, R41 is a radius of curvature of the object side surface of the fourth lens, and Td23 is an air interval from the image side surface of the second lens to the object side surface of the third lens along the optical axis.

10. The lens assembly as claimed in claim 2, further comprising a seventh lens disposed between the sixth lens and the image side, wherein:
the second lens is a biconcave lens and comprises a concave surface facing the object side and another concave surface facing the image side;
the third lens is a biconvex lens and further comprises another convex surface facing the object side;
the fifth lens is a meniscus lens with positive refractive power and comprises a concave surface facing the object side and a convex surface facing the image side;
the sixth lens is a biconcave lens with negative refractive power and comprises a concave surface facing the object side and another concave surface facing the image side;
the seventh lens is a biconvex lens with positive refractive power and comprises a convex surface facing the object side and another convex surface facing the image side; and
the fifth lens and the sixth lens are cemented.

11. The lens assembly as claimed in claim 10, further comprising a stop disposed between the third lens and the fourth lens, wherein the lens assembly satisfies at least one of following conditions:
$$0.95 \leq f 4 / f \leq 3.45 ;$$
$$0.4 \leq Vd 2 / Vd 3 \leq 2.2 ;$$
$$3 mm \leq \vert R 22 - R 31 \vert \leq 80 mm ;$$
$$1.2 \leq f 3 / f \leq 6.8 ;$$
$$- 21.5 mm \leq ( R 21 \times R 22 ) / f 2 \leq 32.5 mm ;$$
$$- 15 \leq ( f 1 + f 2 ) / f \leq - 3 ;$$
$$- 111 \leq fF / f \leq 2.2 ;$$
$$0.1 \leq Tz / BFL \leq 1.4 ;$$
$$62 \leq Vd 4 \leq 68 ;$$
$$4 \leq dSI / Td 23 \leq 94 ;$$
$$0.05 \leq CT 2 / Td 23 \leq 13.35 ;$$
$$0.9 \leq CT 3 / Td 23 \leq 9.9 ;$$
$$0.4 \leq CT 4 / Td 23 \leq 11.8 ;$$
$$0.7 \leq CT 6 / Td 23 \leq 14.3 ;$$
wherein CT2 is an interval from the object side surface of the second lens to an image side surface of the second lens along the optical axis, CT3 is an interval from an object side surface of the third lens to the image side surface of the third lens along the optical axis, CT4 is an interval from the object side surface of the fourth lens to the image side surface of the fourth lens along the optical axis, CT6 is an interval from an object side surface of the sixth lens to an image side surface of the sixth lens along the optical axis, f1 is the effective focal length of the first lens, f2 is an effective focal length of the second lens, f3 is an effective focal length of the third lens, f4 is an effective focal length of the fourth lens, f is the effective focal length of the lens assembly, fF is an effective focal length of a combination of the lenses between the object side and the stop, Tz is an interval from an object side surface of the lens closest to the image side to an image side surface of the lens closest to the image side along the optical axis, BFL is an interval from the image side surface of the lens closest to the image side to the image plane along the optical axis, dSI is an interval from the stop to the image plane along the optical axis, Vd2 is an Abbe number of the second lens, Vd3 is an Abbe number of the third lens, Vd4 is an Abbe number of the fourth lens, R21 is a radius of curvature of the object side surface of the second lens, R22 is a radius of curvature of the image side surface of the second lens, R31 is a radius of curvature of the object side surface of the third lens, and Td23 is an air interval from the image side surface of the second lens to the object side surface of the third lens along the optical axis.

12. A lens assembly comprising:
a first lens which is with negative refractive power;
a second lens which is with refractive power;
a third lens which is with positive refractive power and comprises a convex surface facing an image side;
a fourth lens which is with positive refractive power and comprises a convex surface facing an object side;
a fifth lens which is with refractive power;
a sixth lens which is with refractive power; and
a seventh lens which is with refractive power;
wherein the first lens, the seventh lens, the second lens, the third lens, the fourth lens, the fifth lens, and the sixth lens are arranged in order from the object side to the image side along an optical axis.

13. The lens assembly as claimed in claim 12, wherein:
the first lens is a meniscus lens and comprises a convex surface facing the object side and a concave surface facing the image side;
the second lens is a meniscus lens with negative refractive power and comprises a convex surface facing the object side and a concave surface facing the image side;
the third lens is a biconvex lens and further comprises another convex surface facing the object side;
the fourth lens is a biconvex lens and further comprises another convex surface facing the image side;
the fifth lens is a biconcave lens with negative refractive power and comprises a concave surface facing the object side and another concave surface facing the image side;
the sixth lens is a biconvex lens with positive refractive power and comprises a convex surface facing the object side and another convex surface facing the image side; and
the seventh lens is a meniscus lens with positive refractive power and comprises a concave surface facing the object side and a convex surface facing the image side.

14. The lens assembly as claimed in claim 12, further comprising an eighth lens disposed between the sixth lens and the image side, wherein:
the first lens is a meniscus lens and comprises a convex surface facing the object side and a concave surface facing the image side;
the second lens is a biconcave lens with negative refractive power and comprises a concave surface facing the object side and another concave surface facing the image side;
the third lens is a meniscus lens and further comprises a concave surface facing the object side;
the fourth lens is a biconvex lens and further comprises another convex surface facing the image side;
the fifth lens is a meniscus lens with negative refractive power and comprises a convex surface facing the object side and a concave surface facing the image side;
the sixth lens is a biconvex lens with positive refractive power and comprises a convex surface facing the object side and another convex surface facing the image side;
the seventh lens is a biconvex lens with positive refractive power and comprises a convex surface facing the object side and another convex surface facing the image side;
the eighth lens is a meniscus lens with negative refractive power and comprises a concave surface facing the object side and a convex surface facing the image side; and
the fifth lens and the sixth lens are cemented.

15. The lens assembly as claimed in claim 14, further comprising a stop disposed between the third lens and the fourth lens, wherein the lens assembly satisfies at least one of following conditions:
$$1.4 \leq CT 4 / L 4 T 2 \leq 3.2 ;$$
$$0.95 \leq f 4 / f \leq 3.45 ;$$
$$0.4 \leq Vd 2 / Vd 3 \leq 2.2 ;$$
$$2 \leq Vd 4 / Vd 5 \leq 4.1 ;$$
$$0.3 \leq Vd 5 / Vd 6 \leq 0.42 ;$$
$$3 mm \leq \vert R 22 - R 31 \vert \leq 80 mm ;$$
$$1.2 \leq f 3 / f \leq 6.8 ;$$
$$- 17 degree / mm \leq FOV / f 1 \leq - 4 degree / mm ;$$
$$- 21.5 mm \leq ( R 21 \times R 22 ) / f 2 \leq 32.5 mm ;$$
$$- 15 \leq ( f 1 + f 2 ) / f \leq - 3 ;$$
$$- 111 \leq fF / f \leq 2.2 ;$$
$$0.1 \leq Tz / BFL \leq 1.4 ;$$
$$62 \leq Vd 4 \leq 68 ;$$
$$4 \leq dSI / Td 23 \leq 94 ;$$
$$5.9 \leq ( R 41 - R 32 ) / CT 6 \leq 15.1 ;$$
$$0.05 \leq CT 2 / Td 23 \leq 13.35 ;$$
$$0.9 \leq CT 3 / Td 23 \leq 9.9 ;$$
$$0.4 \leq CT 4 / Td 23 \leq 11.8 ;$$
$$0.7 \leq CT 6 / Td 23 \leq 14.3 ;$$
wherein FOV is a field of view of the lens assembly, CT2 is an interval from the object side surface of the second lens to an image side surface of the second lens along the optical axis, CT3 is an interval from an object side surface of the third lens to the image side surface of the third lens along the optical axis, CT4 is an interval from the object side surface of the fourth lens to the image side surface of the fourth lens along the optical axis, CT6 is an interval from an object side surface of the sixth lens to an image side surface of the sixth lens along the optical axis, LAT2 is an interval from the outermost edge of the object side surface of the fourth lens to the outermost edge of the image side surface of the fourth lens along the optical axis, f1 is the effective focal length of the first lens, f2 is an effective focal length of the second lens, f3 is an effective focal length of the third lens, f4 is an effective focal length of the fourth lens, f is the effective focal length of the lens assembly, fF is an effective focal length of a combination of the lenses between the object side and the stop, Tz is an interval from an object side surface of the lens closest to the image side to an image side surface of the lens closest to the image side along the optical axis, BFL is an interval from the image side surface of the lens closest to the image side to the image plane along the optical axis, dSI is an interval from the stop to the image plane along the optical axis, Vd2 is an Abbe number of the second lens, Vd3 is an Abbe number of the third lens, Vd4 is an Abbe number of the fourth lens, Vd5 is an Abbe number of the fifth lens, Vd6 is an Abbe number of the sixth lens, R21 is a radius of curvature of the object side surface of the second lens, R22 is a radius of curvature of the image side surface of the second lens, R31 is a radius of curvature of the object side surface of the third lens, R32 is a radius of curvature of the image side surface of the third lens, R41 is a radius of curvature of the object side surface of the fourth lens, and Td23 is an air interval from the image side surface of the second lens to the object side surface of the third lens along the optical axis.

16. The lens assembly as claimed in claim 12, wherein:
the first lens is a meniscus lens and comprises a convex surface facing the object side and a concave surface facing the image side;
the second lens is a meniscus lens with negative refractive power and comprises a concave surface facing the object side and a convex surface facing the image side;
the third lens is a biconvex lens and further comprises another convex surface facing the object side;
the fourth lens is a biconvex lens and further comprises another convex surface facing the image side;
the fifth lens is a biconcave lens with negative refractive power and comprises a concave surface facing the object side and another concave surface facing the image side;
the sixth lens is a biconvex lens with positive refractive power and comprises a convex surface facing the object side and another convex surface facing the image side; and
the seventh lens is a meniscus lens with positive refractive power and comprises a concave surface facing the object side and a convex surface facing the image side.

17. The lens assembly as claimed in claim 16, further comprising a stop disposed between the third lens and the fourth lens, wherein the lens assembly satisfies at least one of following conditions:
$$1.4 \leq CT 4 / L 4 T 2 \leq 3.2 ;$$
$$0.95 \leq f 4 / f \leq 3.45 ;$$
$$0.4 \leq Vd 2 / Vd 3 \leq 2.2 ;$$
$$2 \leq Vd 4 / Vd 5 \leq 4.1 ;$$
$$0.3 \leq Vd 5 / Vd 6 \leq 0.42 ;$$
$$1.2 \leq f 3 / f \leq 6.8 ;$$
$$- 17 degree / mm \leq FOV / f 1 \leq - 4 degree / mm ;$$
$$- 15 \leq ( f 1 + f 2 ) / f \leq - 3 ;$$
$$0.1 \leq Tz / BFL \leq 1.4 ;$$
$$4 \leq dSI / Td 23 \leq 94 ;$$
$$0.05 \leq CT 2 / Td 23 \leq 13.35 ;$$
$$0.9 \leq CT 3 / Td 23 \leq 9.9 ;$$
$$0.4 \leq CT 4 / Td 23 \leq 11.8 ;$$
$$0.7 \leq CT 6 / Td 23 \leq 14.3 ;$$
wherein FOV is a field of view of the lens assembly, CT2 is an interval from the object side surface of the second lens to an image side surface of the second lens along the optical axis, CT3 is an interval from an object side surface of the third lens to the image side surface of the third lens along the optical axis, CT4 is an interval from the object side surface of the fourth lens to the image side surface of the fourth lens along the optical axis, CT6 is an interval from an object side surface of the sixth lens to an image side surface of the sixth lens along the optical axis, LAT2 is an interval from the outermost edge of the object side surface of the fourth lens to the outermost edge of the image side surface of the fourth lens along the optical axis, f1 is the effective focal length of the first lens, f2 is an effective focal length of the second lens, f3 is an effective focal length of the third lens, f4 is an effective focal length of the fourth lens, f is the effective focal length of the lens assembly, Tz is an interval from an object side surface of the lens closest to the image side to an image side surface of the lens closest to the image side along the optical axis, BFL is an interval from the image side surface of the lens closest to the image side to the image plane along the optical axis, dSI is an interval from the stop to the image plane along the optical axis, Vd2 is an Abbe number of the second lens, Vd3 is an Abbe number of the third lens, Vd4 is an Abbe number of the fourth lens, Vd5 is an Abbe number of the fifth lens, Vd6 is an Abbe number of the sixth lens, and Td23 is an air interval from the image side surface of the second lens to the object side surface of the third lens along the optical axis.

18. A lens assembly comprising:
a first lens which is with negative refractive power;
a second lens which is with refractive power;
a third lens which is with positive refractive power and comprises a convex surface facing an image side;
a fourth lens which is with positive refractive power and comprises a convex surface facing an object side;
a fifth lens which is with refractive power;
a sixth lens which is with refractive power; and
a seventh lens which is with refractive power;
wherein the first lens, the second lens, the third lens, the fourth lens, the fifth lens, the sixth lens, and the seventh lens are arranged in order from the object side to the image side along an optical axis.

19. The lens assembly as claimed in claim 18, wherein:
the first lens is a meniscus lens and comprises a convex surface facing the object side and a concave surface facing the image side;
the second lens is a meniscus lens with negative refractive power and comprises a convex surface facing the object side and a concave surface facing the image side;
the third lens is a meniscus lens and further comprises a concave surface facing the object side;
the fourth lens is a biconvex lens and further comprises another convex surface facing the image side;
the fifth lens is a meniscus lens with negative refractive power and comprises a convex surface facing the object side and a concave surface facing the image side;
the sixth lens is a biconvex lens with positive refractive power and comprises a convex surface facing the object side and another convex surface facing the image side;
the seventh lens is a meniscus lens with negative refractive power and comprises a concave surface facing the object side and a convex 18 surface facing the image side; and
the fifth lens and the sixth lens are cemented.

20. The lens assembly as claimed in claim 19, further comprising a stop disposed between the third lens and the fourth lens, wherein the lens assembly satisfies at least one of following conditions:
$$1.4 \leq CT 4 / L 4 T 2 \leq 3.2 ;$$
$$0.95 \leq f 4 / f \leq 3.45 ;$$
$$0.4 \leq Vd 2 / Vd 3 \leq 2.2 ;$$
$$2 \leq Vd 4 / Vd 5 \leq 4.1 ;$$
$$0.3 \leq Vd 5 / Vd 6 \leq 0.42 ;$$
$$3 mm \leq \vert R 22 - R 31 \vert \leq 80 mm ;$$
$$1.2 \leq f 3 / f \leq 6.8 ;$$
$$- 17 degree / mm \leq FOV / f 1 \leq - 4 degree / mm ;$$
$$- 21.5 mm \leq ( R 21 \times R 22 ) / f 2 \leq 32.5 mm ;$$
$$- 15 \leq ( f 1 + f 2 ) / f \leq - 3 ;$$
$$- 111 \leq fF / f \leq 2.2 ;$$
$$0.1 \leq Tz / BFL \leq 1.4 ;$$
$$4 \leq dSI / Td 23 \leq 94 ;$$
$$5.9 \leq ( R 41 - R 32 ) / CT 6 \leq 15.1 ;$$
$$0.05 \leq CT 2 / Td 23 \leq 13.35 ;$$
$$0.9 \leq CT 3 / Td 23 \leq 9.9 ;$$
$$0.4 \leq CT 4 / Td 23 \leq 11.8 ;$$
$$0.7 \leq CT 6 / Td 23 \leq 14.3 ;$$
wherein FOV is a field of view of the lens assembly, CT2 is an interval from the object side surface of the second lens to an image side surface of the second lens along the optical axis, CT3 is an interval from an object side surface of the third lens to the image side surface of the third lens along the optical axis, CT4 is an interval from the object side surface of the fourth lens to the image side surface of the fourth lens along the optical axis, CT6 is an interval from an object side surface of the sixth lens to an image side surface of the sixth lens along the optical axis, LAT2 is an interval from the outermost edge of the object side surface of the fourth lens to the outermost edge of the image side surface of the fourth lens along the optical axis, f1 is the effective focal length of the first lens, f2 is an effective focal length of the second lens, f3 is an effective focal length of the third lens, f4 is an effective focal length of the fourth lens, f is the effective focal length of the lens assembly, fF is an effective focal length of a combination of the lenses between the object side and the stop, Tz is an interval from an object side surface of the lens closest to the image side to an image side surface of the lens closest to the image side along the optical axis, BFL is an interval from the image side surface of the lens closest to the image side to the image plane along the optical axis, dSI is an interval from the stop to the image plane along the optical axis, Vd2 is an Abbe number of the second lens, Vd3 is an Abbe number of the third lens, Vd4 is an Abbe number of the fourth lens, Vd5 is an Abbe number of the fifth lens, Vd6 is an Abbe number of the sixth lens, R21 is a radius of curvature of the object side surface of the second lens, R22 is a radius of curvature of the image side surface of the second lens, R31 is a radius of curvature of the object side surface of the third lens, R32 is a radius of curvature of the image side surface of the third lens, R41 is a radius of curvature of the object side surface of the fourth lens, and Td23 is an air interval from the image side surface of the second lens to the object side surface of the third lens along the optical axis.
